(19) United States
(12) Patent Application Publication
(10) Pub. No.: US 2024/0385333 A1
(43) Pub. Date: Nov. 21, 2024

(54) VEHICLE NAVIGATION COMBINING TRANSMITTED OBJECT LOCATION INFORMATION AND SENSOR-BASED RELATIVE OBJECT LOCATION INFORMATION

(71) Applicant: Israel Aerospace Industries Ltd., Lod (IL)

(72) Inventor: Nir TEL OREN, Tel Aviv (IL)

(21) Appl. No.: 18/293,614

(22) PCT Filed: Jun. 29, 2022
(86) PCT No.: PCT/IL2022/050697

§ 371 Date: Jan. 30, 2024

(30) Foreign Application Priority Data
Sep. 1, 2021 (IL) 286034

(51) Int. Cl. G01S 19/48; G01S 19/39; G01S 19/40

(52) U.S. Cl. CPC G01S 19/48; G01S 19/396; G01S 19/40

(57) ABSTRACT

A computerized positioning system is associated with a vehicle. It is configured to perform the following method: (a) receive first information indicative transmission(s), wherein the transmission is associated with an object(s). The first information comprises item(s) of object first position information associated with the object. The item of object first position information is indicative of an object absolute position. (b) receive second position information of the object, being indicative of a second relative position of the object with respect to the vehicle. (c) determine a derived position of the vehicle, based at least on the first information and on the second position information. The derived position is capable of being utilized to facilitate a correction in a reported position of the vehicle. The reported position is based on GNSS signal(s) received by GNSS receiver(s) associated with the vehicle.

### TECHNICAL FIELD

The presently disclosed subject matter relates to positioning and navigation of vehicles, e.g. airborne vehicles.

### BACKGROUND

Some problems with using GPS for maritime applications disclosed, for example, in “GPS Jamming and its impact on maritime navigation”, Dr. Alan Grant, 10 May 2010, Royal Institute of Navigation, Research and Development-Special Interest Group.

The document Daniel Medina et al, “On GNSS Jamming Threat from the Maritime Navigation Perspective”, IEEE, 2019 22th International Conference on Information Fusion (FUSION), 2-5 Jul. 2019, retrieved at https://core.ac.uk/download/pdf/220158826.pdf, discloses the GNSS jamming threat, as well as use of Multi Sensor Fusion for mitigating the effects of GNSS jamming.

The Automatic Identification System (AIS) is disclosed for example in “The Definitive AIS Handbook”, BigOceanData Global Vessel Management Solutions.

Government authorities issue advisories concerning areas of known GNSS interference. See e.g. the web page https://safety4sea.com/us-marad-warns-maritime-about-gps-interference/and https://safety4sea.com/areas-with-rising-gps-interference-and-jamming-incidents/, referring to an advisory by the US Maritime Administration (MARAD), stating, inter alia, “Multiple instances of significant GPS interference have been reported worldwide in the maritime domain, says US MARAD . . . . . For this reason, exercise caution when operating underway and prior to getting underway”.

Acknowledgement of the above references herein is not to be inferred as meaning that these are in any way relevant to the patentability of the presently disclosed subject matter.

### GENERAL DESCRIPTION

According to a first aspect of the presently disclosed subject matter there is presented a computerized positioning system associated with a vehicle, the computerized positioning system comprising a processing circuitry, the processing circuitry configured to perform the following method:
a. receive first information indicative of at least one transmission, wherein the transmission is associated with at least one object, wherein the first information comprises at least one item of object first
position information associated with the at least one object, wherein the at least one item of object first position information is
indicative of an absolute position of the at least one object;
b. receive second position information of the at least one object, the second position information being indicative of a second relative position of the at least one object with respect to the vehicle;
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.

In addition to the above features, the method according to this aspect of the presently disclosed subject matter can include one or more of features (i) to (lviii) listed below, in any desired combination or permutation which is technically possible:
(i) the first information comprises at least one item of object identification information of the at least one object.
(ii) the method further comprising:
   d. determining a deviation between the derived position and the reported position of the vehicle;
(iii) the method further comprising:
   e. sending an alert indicative of the determined deviation.
(iv) the alert is sent to at least one of: a user interface associated with a human operator; an autonomous navigation system; an external system.
(v) the method further comprising:
   f. sending a correction instruction to correct the reported position of the vehicle, thereby deriving a corrected reported position of the vehicle.
(vi) the instruction is sent to at least one of: a user interface associated with a human operator; an autonomous navigation system; an external system.
(vii) the method further comprising:
   g. navigating the vehicle based on the corrected reported position of the vehicle.
(viii) The computerized positioning system of any one of claims 1 to 8, wherein the processing circuitry is further configured to perform at least one repetition of the method,
thereby enabling a tracking of the corrected reported position.
(ix) the derived position is capable of being utilized in a case of a disruption associated with the at least one GNSS signal.
(x) the disruption comprises least one: of jamming, interference or spoofing of the at least one GNSS signal, GNSS receiver failure, GNSS antenna failure.
(xi) the received GNSS signal(s) and the at least one GNSS receiver are associated with at least one of the following technologies: Global Positioning System (GPS), Global Navigation Satellite System (GLONASS) and Galileo.
(xii) the transmission is received from at least one of a transmitter and a transponder that are associated with the at least one object.
(xiii) the transponder is an Automatic Identification system (AIS) transponder.
(xiv) the vehicle is associated with a receiver configured for receiving the transmission.
(xv) the object identification information of the at least one object comprises at least one of: a MMSI (Maritime Mobile Service Identity); a name of the at least one object, a call sign of the at least one object.
(xvi) the object first position information associated with the at least one object comprising GNSS position information of the at least one object.
(xvii) the object first position information associated with the at least one object
(xviii) the determining of the derived position of the vehicle in said step (c), based at least on the first information and on the second position information, comprises determining a derived absolute position of the vehicle.
(xix) The computerized positioning system of the previous claim,
   wherein the receiving of the second position information comprises receiving second position information indicative of a second relative position of at least one second object with respect to the vehicle,
   wherein the determining of the derived absolute position of the vehicle in said step (c) comprises:
      i. perform a first matching of an object second relative position, of at least one second object, with the at least one item of object first position information, comprised in the first information, associated with the at least one first object,
         thereby deriving absolute position information of the at least one second object;
      ii. setting each matched second object of the at least one second object to constitute a corresponding object of the at least one object; and
      iii. determine the derived absolute position of the vehicle based at least on absolute position information of the corresponding object and on the at least one object second relative position.
(xx) the first matching is based on the at least one item of object first position information, and the object relative second position, being indicative of a same position, within a defined tolerance.
(xxi) the at least one object comprises a plurality of objects,
   wherein said step (c) (iii) comprises determining the derived absolute position of the vehicle based at least on absolute position information of a plurality of corresponding objects and on object second relative positions of the plurality of corresponding objects.
(xxii) the first matching comprises comparing a first map and a second map,
the first map being indicative of the at least one item of object first position information,
the second map being indicative of the at least one object second relative position.
(xxiii) the setting each matched second object comprises: performing a second matching of the at least one object, with the at least one second object, based on the first matching.
(xxiv) the setting each matched second object further comprising:
associating the object identification information of the each matched second object with the corresponding object of the at least one object.
(xxv) the vehicle is associated with at least one sensor,
   wherein the second position information being based on sensor data obtained from the at least one sensor,
   wherein the second relative position comprising a range of the at least one object and at least one relative angle of the at least one object
(xxvi) the sensor(s) comprises at least one of: a Radio Detection and Ranging (RADAR) system; an Identification Friend or Foe (IFF) system; and Automatic Dependent Surveillance-Broadcast (ADS-B) system.
(xxvii) the sensor(s) comprising a range finder and at least one imaging sensor.
(xxviii) the sensor(s) comprising at least one camera.
(xxix) the second relative positions of each object of the plurality of objects, with respect to the vehicle, comprise corresponding object ranges of the each object with respect to the vehicle,
   wherein the determining of the derived position of the vehicle is based on am intersection of the corresponding object ranges.
(xxx) the object(s) comprises a plurality of objects,
   wherein the determining of the derived position of the vehicle is based on an intersection of second relative positions of objects of the plurality of objects,
      wherein the at least one object comprises a plurality of objects,
      wherein second relative positions of each object of the plurality of objects, with respect to the vehicle, comprise corresponding object relative angles of the each object,
      wherein the determining of the derived position of the vehicle is based on a triangulation of the corresponding object relative angles.
(xxxi) the at least one imaging sensor configured for capturing images associated with multiple view directions relative to the vehicle.
(xxxii) the at least one imaging sensor comprising a plurality of imaging sensors, the plurality of imaging sensors configured with non-identical view directions.
(xxxiii) the receiving of the first information comprises receiving an internet feed indicative of the first information,
   wherein the determining of the derived position of the vehicle is based at least on the internet feed.
(xxxiv) the internet feed comprises an internet update of AIS information.
(xxxv) the internet feed is received from at least one satellite.
(xxxvi) the object(s) comprises a plurality of objects,
   wherein the determining of the derived position of the vehicle in said step (c) further comprises:
      iv. for each object of the plurality of objects, determining a quality metric associated with a corresponding item of object identification information;
      v. performing at least one of the following:
   (1) select objects of the plurality of objects, to be utilized in the determining of the derived position, based on the quality metric of each object; and
   (2) assigning an object weight of each object, based on the quality metric, and determining the derived position at least based on the object weight.
(xxxvii) the quality metric of each object is based at least on a level of geographic reasonableness associated with a corresponding item of object first position information of each object.
(xxxviii) the determination of the derived position of the vehicle excludes objects of the at least one object, for which the corresponding first information does not include the at least one item of object position information.
(xxxix) the objects(s) comprises a plurality of objects, wherein the determining of the derived position in said step (c) further comprises the following:
   vi. defining a plurality of unique sub-sets of objects of the plurality of objects;
   vii. performing an interim position determination, based on a sub-set of the plurality of unique sub-sets,
   viii. thereby obtaining an interim value of the derived position of the vehicle;
   ix. determining a position weight associated with the interim value;
   x. repeating said steps (vi) to (viii) for each sub-set of the plurality of unique sub-sets,
      thereby deriving a plurality of interim values associated with corresponding position weights;
   xi. weight the plurality of interim values, based at least on the corresponding position weights,
      thereby deriving a final value of the derived position of the vehicle, the final value constituting the derived position of the vehicle.
(xl) the defining of the plurality of unique sub-sets is based at least on the selecting of the objects to be utilized.
(xli) the determining of the position weight is based at least on a corresponding object weight of each object in the sub-set.
(xlii) in a case where an interim value of the plurality of interim values differs, above a defined threshold, from at least one of other interim values and a prior derived position of the vehicle,
   performing the weighting of the plurality of interim values while excluding the divergent interim value.
(xliii) the determining of the derived position of the vehicle utilizes a geo-registration process.
(xliv) the at least one item of first position information and the second object position information are indicative of a direction of the at least one object, wherein the determining of the derived position of the vehicle is based at least on the direction.
(xlv) the at least one item of first position information and the second object position information are indicative of a speed of the at least one object, wherein the determining of the derived position of the vehicle is based at least on the speed.
(xlvi) the determination of the derived position of the vehicle is based at least on an altitude of the vehicle.
(xlvii) wherein the method further comprising, in a case where the second position information is indicative of an insufficient number of the at least one object, sending an instruction to the vehicle to increase the altitude.
(xlviii) wherein the method further comprising, in a case where the second position information is indicative of an insufficient number of the at least one object, sending an instruction to the vehicle to move to a geographical area comprising a larger number of objects.
(xlix) the at least one object is one object.
(l) the vehicle is an airborne vehicle.
(li) the airborne vehicle is a patrol aircraft.
(lii) the patrol aircraft is a Maritime Patrol Aircraft (MPA).
(liii) the airborne vehicle is an Unmanned Aerial Vehicle (UAV).
(liv) the at least one object comprises at least one water-borne vehicle.
(lv) the at least one water-borne vehicle comprises at least one ship.
(lvi) the at least one water-borne vehicle is located in one of: an ocean; a sea; a lake; a river.
(lvii) the at least one object comprises at least one ground vehicle.
(lviii) the at least one object comprises at least one fixed-position object.

According to a second aspect of the presently disclosed subject matter there is presented a computerized method of positioning a vehicle, the method configured to be performed by a computerized positioning system comprising a processing circuitry, the method comprising, performing the following by the processing circuitry:
a. receive first information indicative of at least one transmission,
   wherein the transmission is associated with at least one object,
   wherein the first information comprises at least one item of object first position information associated with the at least one object,
   wherein the at least one item of object first position information is indicative of an absolute position of the at least one object;
b. receive second position information of the at least one object, the second position information being indicative of a second relative position of the at least one object with respect to the vehicle;
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.

According to a third aspect of the presently disclosed subject matter there is presented a non-transitory computer readable storage medium tangibly embodying a program of instructions that, when executed by a computerized positioning system, cause the computer to perform a computerized method of positioning a vehicle, the method being performed by a processing circuitry of the computerized positioning system and comprising performing the following actions:
a. receive first information indicative of at least one transmission,
   wherein the transmission is associated with at least one object,
   wherein the first information comprises at least one item of object first position information associated with the at least one object,
   wherein the at least one item of object first position information is indicative of an absolute position of the at least one object;
b. receive second position information of the at least one object, the second position information being indicative of a second relative position of the at least one object with respect to the vehicle;
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.

According to a fourth aspect of the presently disclosed subject matter there is presented a computerized method of localization of a vehicle, which is configured to combine AIS and RADAR methods.

According to a fifth aspect of the presently disclosed subject matter there is provided a non-transitory computer readable storage medium tangibly embodying a program of instructions that when executed by a computer, cause the computer to perform the method of the third aspect of the disclosed subject matter.

According to a sixth aspect of the presently disclosed subject matter there is provided a computerized system, comprising a processing circuitry, configured to perform the method of the third aspect of the disclosed subject matter.

The second to sixth aspects of the disclosed subject matter can optionally include one or more of features (i) to (lviii) listed above, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates schematically an example generalized view of relative positioning, in accordance with some embodiments of the presently disclosed subject matter;

FIG. 1B illustrates schematically an example generalized view of object transmissions, in accordance with some embodiments of the presently disclosed subject matter;

FIG. 2 illustrates schematically an example generalized view of a map overlay, in accordance with some embodiments of the presently disclosed subject matter;

FIG. 3A illustrates schematically a generalized example schematic diagram of a vehicle positioning solution, in accordance with some embodiments of the presently disclosed subject matter;

FIG. 3B illustrates schematically a generalized example schematic diagram of computerized positioning system, in accordance with some embodiments of the presently disclosed subject matter;

FIG. 4 illustrates schematically an example generalized view of a patrol, in accordance with some embodiments of the presently disclosed subject matter;

FIG. 5 schematically illustrates an example generalized view of an object detection method, in accordance with some embodiments of the presently disclosed subject matter;

FIG. 6 schematically illustrates an example generalized view of an object detection method, in accordance with some embodiments of the presently disclosed subject matter;

FIG. 7 schematically illustrates an example generalized view of an object detection method, in accordance with some embodiments of the presently disclosed subject matter; and

FIGS. 8A, 8B, 8C and 8D illustrate one example of a generalized flow chart diagram, of a flow of a process or method, for positioning of a vehicle, in accordance with some embodiments of the presently disclosed subject matter.

### DETAILED DESCRIPTION

In the drawings and descriptions set forth, identical reference numerals indicate those components that are common to different embodiments or configurations.

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

Unless specifically stated otherwise, as apparent from the following discussions, it is appreciated that throughout the specification discussions utilizing terms such as “receiving”, “determining”, “sending”, “alerting”, “setting” or the like, refer to the action(s) and/or process(es) of a computer that manipulate and/or transform data into other data, said data represented as physical, e.g. such as electronic or mechanical quantities, and/or said data representing the physical objects. The term “computer” should be expansively construed to cover any kind of hardware-based electronic device with data processing capabilities including a personal computer, a server, a computing system, a communication device, a processor or processing unit (e.g. digital signal processor (DSP), a microcontroller, a microprocessor, a field programmable gate array (FPGA), an application specific integrated circuit (ASIC), etc.), and any other electronic computing device, including, by way of non-limiting example, computerized system 310 and processing circuitry 312, disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The terms “non-transitory memory” and “non-transitory storage medium” used herein should be expansively construed to cover any volatile or non-volatile computer memory suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases”, “one example”, “some examples”, “other examples”, or variants thereof, means that a particular described method, procedure, component, structure, feature or characteristic described in connection with the embodiment(s) is included in at least one embodiment of the presently disclosed subject matter, but not necessarily in all embodiments. The appearance of the same term does not necessarily refer to the same embodiment(s) or example(s).

Usage of conditional language, such as “may”, “might”, or variants thereof, should be construed as conveying that one or more examples of the subject matter may include, while one or more other examples of the subject matter may not necessarily include, certain methods, procedures, components and features. Thus such conditional language is not generally intended to imply that a particular described method, procedure, component or circuit is necessarily included in all examples of the subject matter. Moreover, the usage of non-conditional language does not necessarily imply that a particular described method, procedure, component or circuit is necessarily included in all examples of the subject matter.

It is appreciated that certain embodiments, methods, procedures, components or features of the presently disclosed subject matter, which are, for clarity, described in the context of separate embodiments or examples, may also be provided in combination in a single embodiment or examples. Conversely, various embodiments, methods, procedures, components or features of the presently disclosed subject matter, which are, for brevity, described in the context of a single embodiment, may also be provided separately or in any suitable sub-combination.

It should also be noted that each of the figures herein, and the text discussion of each figure, describe one aspect of the presently disclosed subject matter in an informative manner only, by way of non-limiting example, for clarity of explanation only. It will be understood that that the teachings of the presently disclosed subject matter are not bound by what is described with reference to any of the figures or described in other documents referenced in this application.

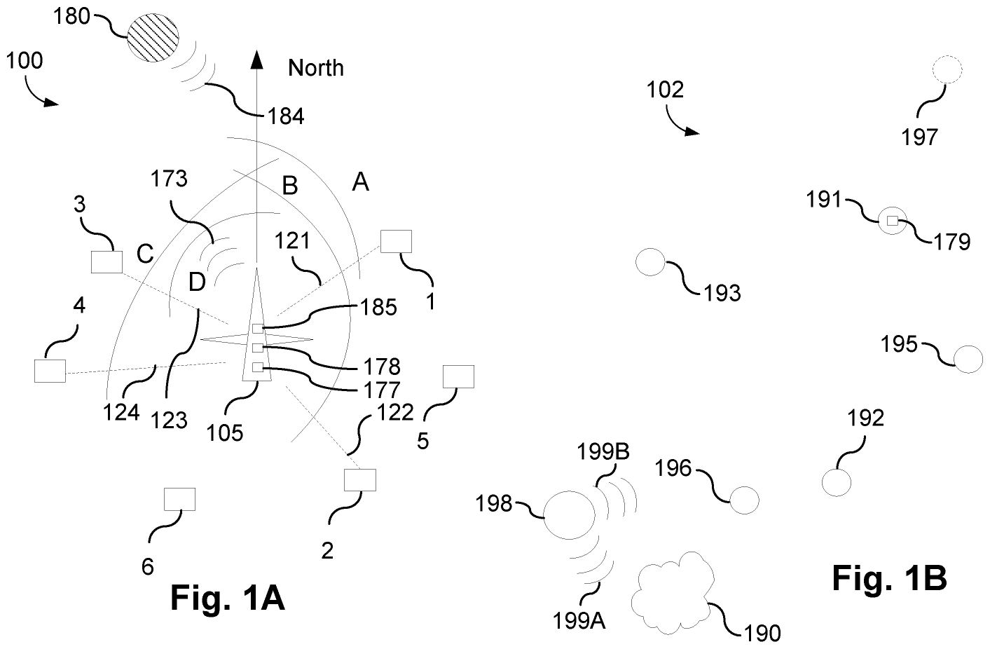

Bearing this in mind, attention is drawn to FIG. 1A, schematically illustrating an example generalized view of relative positioning, in accordance with some embodiments of the presently disclosed subject matter.

A vehicle 105 is shown, e.g. an aircraft or other airborne vehicle 105. In some other examples it is a water-borne vehicle such as a ship or boat 105. It has a Global Navigation Satellite System (GNSS) receiver 185, associated with or comprised in it. Examples of GNSS technologies and systems include Global Positioning System (GPS), Global Navigation Satellite System (GLONASS) and Galileo. GNSS receiver 185 is configured to receive GNSS signals from GNSS satellites 180. (Only one satellite is shown, for ease of exposition.) The GNSS system enables determination of the position of vehicle 105. In some examples, the vehicle's heading, speed etc. can also be determined, e.g. by capturing GNSS positions which are at different points in time during the vehicle movement. In such a manner, the vehicle's movement can be tracked. For example, if an aircraft is flying from point A to point B, the flight may comprise multiple waypoints. In some cases the aircraft flies from waypoint to waypoint, e.g. using its current measured position as a basis for corrections in the flight path towards the next waypoint. GNSS is a very common positioning tool.

In some situations, the GNSS service is compromised, and can no longer be relied on to provide accurate position, and thus to aid in navigation of the vehicle. The GNSS signal is in some way disrupted, degraded or otherwise comprised. Examples of such disruption include one or more of jamming, blocking, interference or spoofing of the GNSS signal(s), malfunction or failure of the GNSS receiver and malfunction/failure of the GNSS a associated with the receiver. These disruptions can be intentional/malicious and/or unintentional.

In some examples, when flying over land, the vehicle position can still be determined based on observed fixed landmarks. For example, if the aircraft sees the Eiffel Tower, a building or/or some other fixed landmark, to starboard, the vehicle relative position can be determined, e.g. by triangulating measurement data of several such landmarks.

By contrast, in the case of flying or otherwise traveling over/on large bodies of water, e.g. seas or oceans, or large lakes, rivers or bays, such fixed landmarks may not exist, or may not exist in sufficient numbers, to be able to determine vehicle position in the absence of GNSS.

In addition, in some cases GNSS can be particularly interfered at sea. For example, hostile, criminal or otherwise malicious ships, boats etc. at sea can intentionally send jamming/interference or spoofing signals. This may be more common when at sea, since in such a location they are away from government jurisdictions and are less-closely monitored by government authorities. In some examples, illegal jamming units are used. In some examples, the malicious party broadcasts a GNSS signal with erroneous information at a relatively high power, thus spoofing the signal. Such cyber threats can cause incorrect determination of e.g. position and bearing/heading. Note also that in some examples the vehicle does not know that the GNSS information is invalid. Such GNSS threats have been identified as a considerable challenge to navigation in a maritime or water-based environment. See for example “GPS Jamming and its impact on maritime navigation”, Dr. Alan Grant, 10 May 2010, Research and Radio Navigation, Royal Institute of Navigation, Research and Development-Special Interest Group.

The document “On GNSS Jamming Threat from the Maritime Navigation Perspective”, Daniel Medina et al, IEEE, 2019 22th International Conference on Information Fusion (FUSION), 2-5 Jul. 2019, discloses a mitigation technique based on multi sensor fusion: “Another way to mitigate the effects of jamming on the positioning is to fuse the information of GNSS with other sensing modalities. Inertial sensors, gyrocompass and the speed log are generally the sensors to accompany GNSS on the task of maritime navigation. Estimating the navigation solution of a multi-sensor system is realized within the framework of Recursive Bayesian Estimation, with the Kalman Filter (KF) being the most widely applied technique.”

However, it should be noted that solutions such as Inertial Navigation Systems (INS) suffer from drift. They therefore in some cases require the availability of GNSS data, to enable corrections to INS-determined position, and to enable e.g. dead reckoning, particularly if the GNSS interruption covers an area of considerable size. Therefore, INS alone is in at least some cases not a sufficient replacement for a disrupted GNSS method.

Similarly, in some cases of travel over land, methods such as triangulation of radio broadcast sources (e.g. from AM radio transmitters/tower) can be used to provide positioning information. However, in at least some cases of flight over water, the transmitters are far from the vehicle, and the accuracy of such positioning is not sufficient for the vehicle's navigational need.

For at least all of the above reasons, a positioning method to replace or to supplement GNSS-based positioning is a particular challenge in the “marine” case, that is in the case of travel over or on bodies of water.

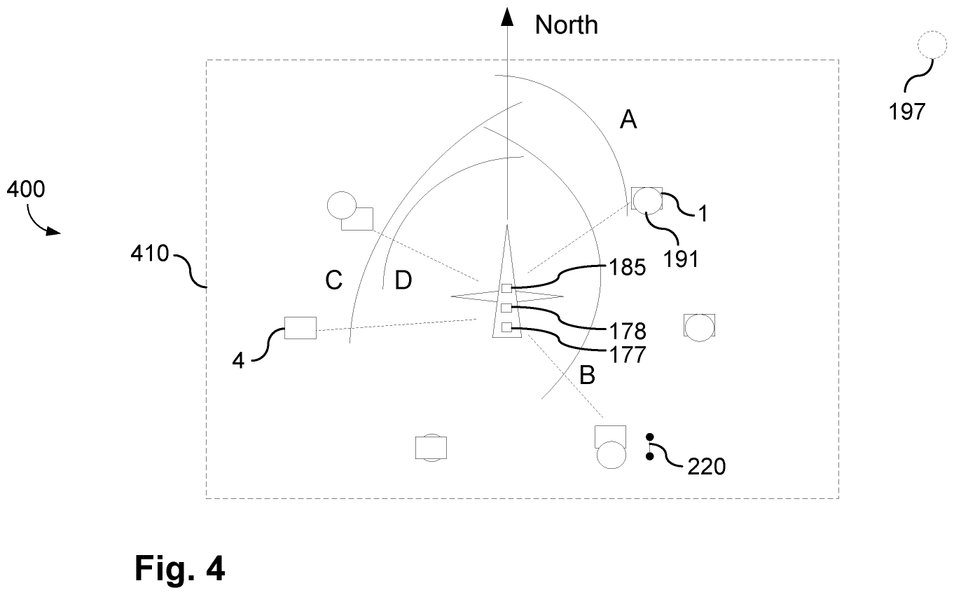

Also, as will be disclosed further herein with reference to FIG. 4, in some examples of patrol missions the GNSS disruption will require the mission to be aborted, and/or the mission will otherwise fail.

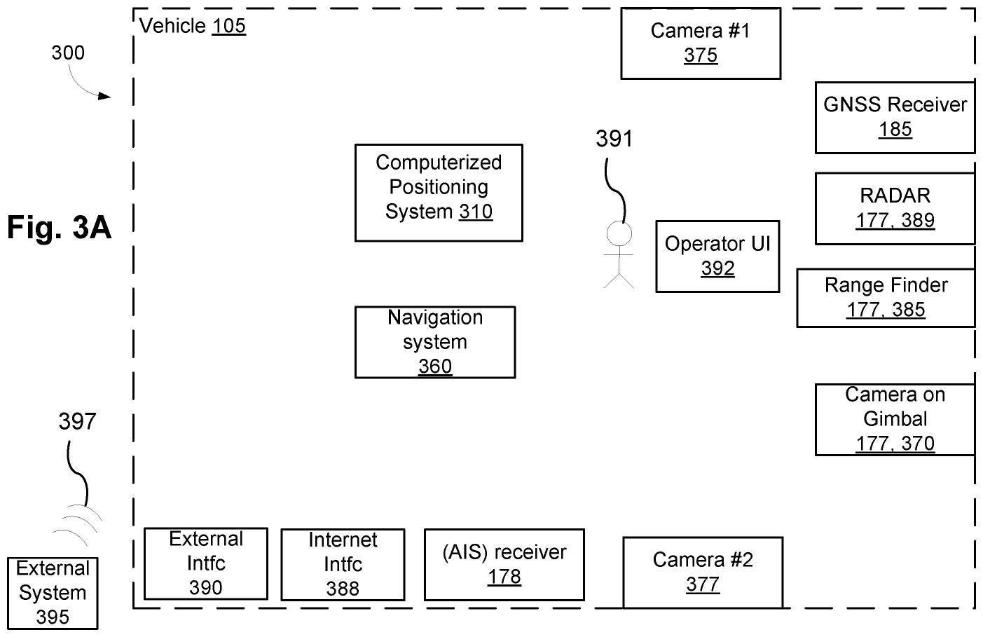

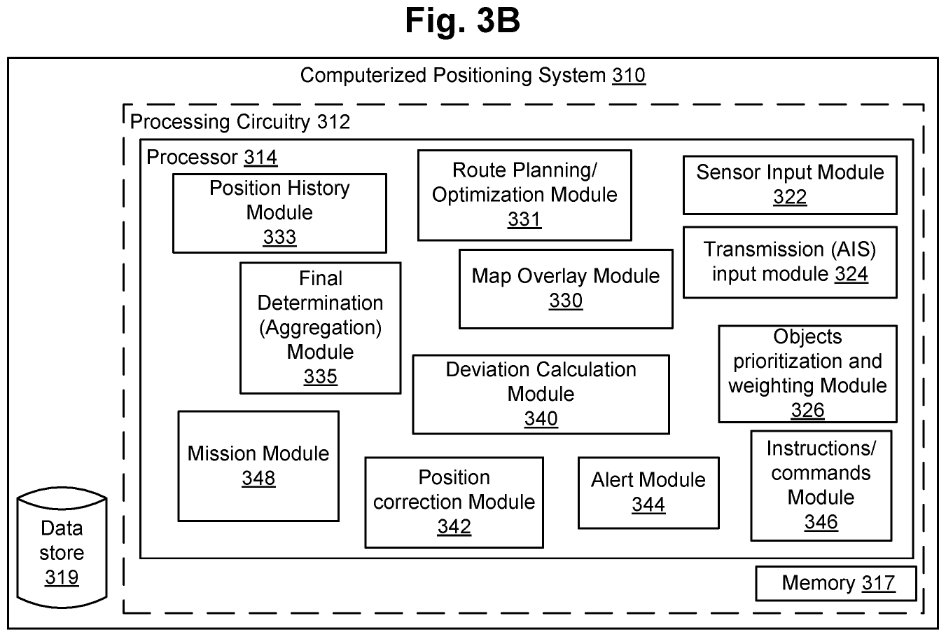

A computerized positioning system associated with a vehicle 105 is disclosed herein, with reference to FIGS. 3A and 3B, which comprises a processing circuitry. A computerized method of localization of a vehicle 105 is disclosed herein, with reference to FIGS. 1A-2 and FIGS. 4-8, which comprises performing the following actions by the processing circuitry:
a. receive first information indicative of at least one transmission. The transmission is associated with one or more objects. The first information comprises one or more items of object first position information associated with the object(s). The item(s) of object first position information is indicative of an absolute position of the object(s).
b. receive second position information of the object(s). The second position information is indicative of a second, relative, position of the object(s) with respect to the vehicle 105.
c. determine a derived position of the vehicle, based at least on the first information and on the second position information.

This derived position of the vehicle 105 is referred to herein also as a self position of the vehicle, since in some examples vehicle 105 is determining its own position. Therefore the method can be referred to herein also as a vehicle self-positioning method.

The derived position of the vehicle is capable of being utilized to facilitate a correction in the reported position of the vehicle, where the reported position of the vehicle is based Global Navigation Satellite Systems (GNSS) signal(s) received by GNSS receiver(s) associated with the vehicle 105.

The one or more objects are referred to herein also as first objects, to distinguish them from second objects disclosed further herein.

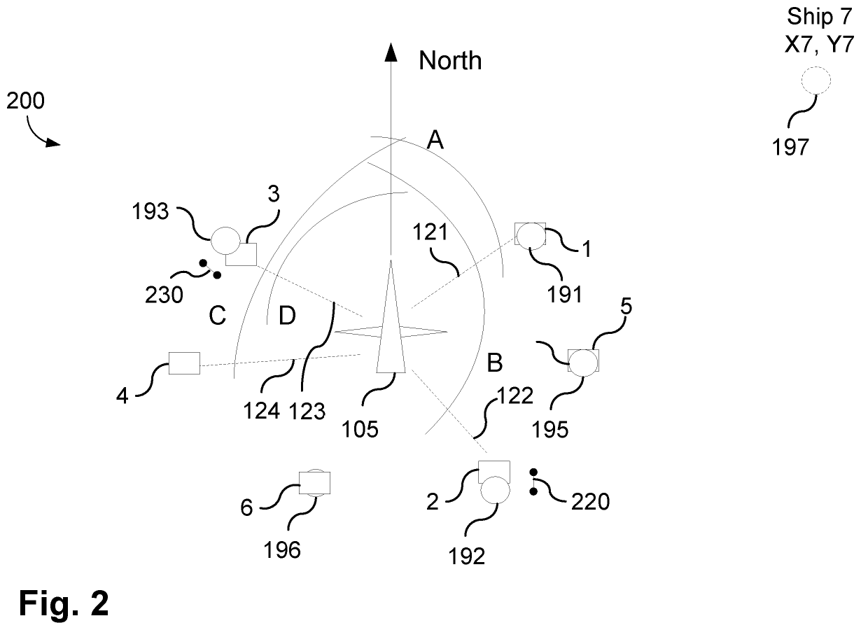

In some cases, the transmission is received from a transmitter 179 or a transponder 179 that are associated with each object. A non-limiting example of such a transponder is an Automatic Identification system (AIS) transponder 179, disclosed with reference to FIG. 2. In some examples, the vehicle 105 is equipped with, or otherwise associated with, a receiver 178 configured for receiving the transmission, e.g. an AIS receiver 178.

In some cases, the vehicle 105 is equipped with, or otherwise associated with, one or more sensors 177, and the second position information is based on sensor data obtained from the sensor(s). In some examples, the second relative position includes at least a range of the object(s) and at least one relative angle of the object(s). One non-limiting example of such a sensor 177 is a Radio Detection and Ranging (RADAR) system. Other technologies or systems that can server for such sensors include Identification Friend or Foe (IFF) systems 177 and Automatic Dependent Surveillance-Broadcast (ADS-B) systems 177.

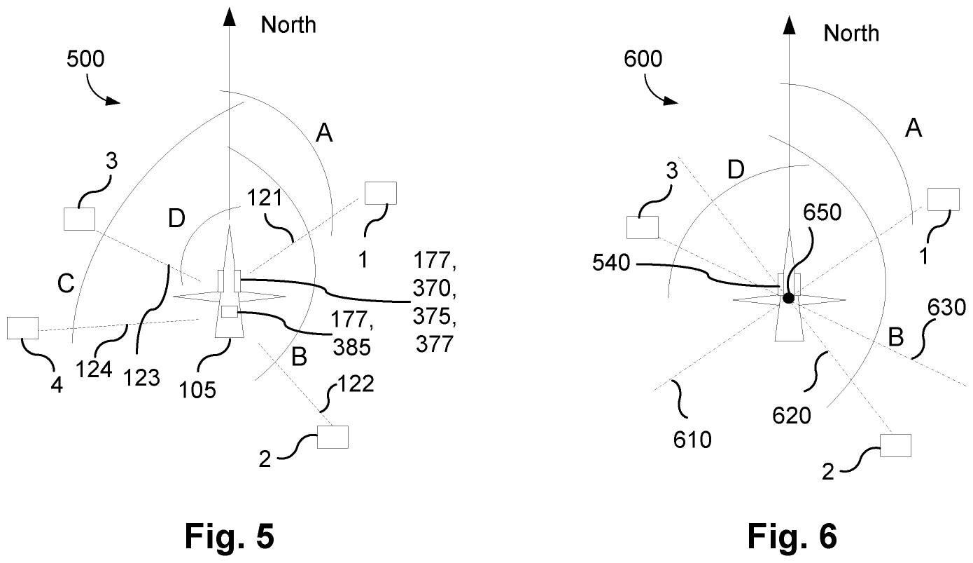

Other implementations of sensors 177 to obtain second position information are disclosed further herein, with reference to FIGS. 5-7.

There is also disclosed herein a computerized system method of localization of a vehicle 105, which combines AIS and RADAR.

Related software products, configured for performing the above-disclosed methods, e.g. utilizing the above-disclosed systems, are also disclosed further herein.

Note also that the presently disclosed method, system and software product enable determining a deviation between the derived position of the vehicle and the GNSS-reported position of the vehicle. In some examples, the vehicle can send an alert indicative of the determined deviation. In some examples, the vehicle can send a correction instruction and/or command, to correct the reported position of the vehicle. In some examples, the vehicle can navigate based on the corrected reported position of the vehicle. Note also that in some examples the method is performed repeatedly, thereby enabling a tracking over time of the corrected reported position. Details of these alerts, instructions, commands, navigation and tracking are disclosed further herein.

Thus, as will be detailed further herein, the derived position of the vehicle, obtained using the presently disclosed subject matter, can provide at least the example advantages of facilitating an improved and more robust and reliable navigation by aircraft or other vehicle 105, over or on bodies of water. As long as there are, for example, a sufficient number of trustworthy vessels or other objects, whose AIS (for example) information can be trusted, the vehicle's 105 actual position can be known, even if the GPS or other GNSS signals are compromised/disrupted. Also, in a case where tracking of the vehicle 105 position is performed over time, also the INS can be corrected, even when the GNSS positioning solution is not functioning correctly.

Similarly, in the case of a patrol mission, disclosed further herein with reference to FIG. 4, the presently disclosed method can enable continuance of the mission in the face of a GNSS disruption.

In some examples, the presently disclosed method is implemented when a GNSS disruption is detected. In some other examples, the presently disclosed method is implemented on an ongoing basis, also when the GNSS is functioning well. For example, when the deviations between the derived position of the vehicle and its GNSS-reported position are above a defined threshold, an alert can be sent of a suspected GNSS problem. In some such cases, from that point on only the presently disclosed method will be relied on for positioning, until such time as it is determined that GNSS function is back to normal. Additional details about this are disclosed further herein.

For ease of exposition only, the methods of FIGS. 1A and 2B will be disclosed with regard to the non-limiting examples of RADAR technology sensors and AIS transponder broadcasts. The presently disclosed method is referred to herein also as the “RADAR plus AIS method” and as the “sensor plus AIS method”, for simplicity of exposition.

Note that many aircraft typically do not carry systems such as Radio Direction and Ranging (RADAR) and Automatic Identification System (AIS) receivers. As will be disclosed further herein, if such equipment is retrofitted to the aircraft, and software is added which is capable of performing the presently disclosed method, the presently disclosed solution can be provided to these aircraft/vehicles 105, to overcome positioning errors cause be e.g. GNSS disruption.

Note that in some prior art implementations, AIS is used for marine tracking services, e.g. as shown in the web site https://www.marinetraffic.com/, or for use in applications such as patrol missions, or other applications disclosed below with reference to FIG. 4. In the presently disclosed subject matter, by contrast, AIS is utilized, together with aircraft sensor data, to enable vehicle self-positioning, so as to facilitate navigation.

Reverting now to FIG. 1A, vehicle 105 is shown, traveling North, purely for simplicity of exposition. In some non-limiting examples, vehicle 105 is an airborne vehicle, e.g. an airplane, helicopter or other aircraft, which is flying over a body of water. In some examples, airborne vehicle 105 is a patrol aircraft, e.g. a Maritime Patrol Aircraft (MPA). In some examples, airborne vehicle 105 is an Unmanned Aerial Vehicle (UAV).

Aircraft 105 is associated with a GNSS receiver 185, which receives GNSS broadcasts 184 from GNSS satellite(s) 180. Only one satellite is shown, for simplicity of exposition. Aircraft 105 is further associated with a receiver 178, configure to receive e.g. AIS transmissions. (More on such transmissions is disclosed further herein with reference to FIG. 1B.)

Aircraft 105 is further associated with a sensor 177, e.g. a RADAR. In the example of the figure, the sensor is configured to provide information indicative of positions, e.g. ranges and angles, of one or more objects 1,2, 3, 4, 5, 6, relative to the vehicle 105. The RADAR signal transmitted is indicated by reference 173. Sensor(s) 177 is referred to herein also as positioning sensor(s) 177, since it collects data which can be used for vehicle positioning purposes.

In some examples the objects 1-6 include water-borne vehicles, e.g. a ship, boat or other aquatic vessel. In some examples these water-borne vehicles are located on e.g. seas or oceans, or large lakes, rivers or bays. In some examples, one or more of objects 1-6 is a ground vehicle. In some examples, one or more of objects 1-6 is a fixed-position object, e.g. a transmitter tower located on the coast of a body of water, which transmits AIS information.

The objects sensed by sensor 177 are shown as squares in the figure. They are referred to herein also as second objects, to distinguish them from the objects of e.g. FIG. 1B.

Based at least on the RADAR or other sensor(s), the vehicle's positioning system (disclosed further herein with reference to FIG. 3) determines that objects 1, 2, 3 and 4 are positioned at ranges 121, 122, 123, 124, correspondingly. Based at least on the RADAR or other sensor(s), the vehicle's positioning system determines that objects 1, 2, 3 and 4 are positioned at angles, A, B, C, D, correspondingly, e.g. measured from North.

The non-limiting example of six objects 1-6 are shown in the figure. For purposes of clarity of exposition, angles and ranges for objects 5 and 6 are not shown.

Based on the range and angle/orientation information, the positioning system determines that the six objects are at e.g. two-dimensional coordinates, relative to the vehicle 105, of XR11, YR11, XR12, YR12, XR 13, YR13, XR14, YR14, XR15, YR15, XR16, YR16. The letters X and Y denote x and y coordinates. The letter R denotes that the coordinate is a relative rather than an absolute one. The numbers 11 to 16 denote, correspondingly, second objects 1-6.

Note that, since the positioning system knows the position of each second object relative to the vehicle 105, it thus knows the inverse, that is the position of the vehicle relative to each object 1-6. This relative position of the vehicle is denoted herein as XVR11, YVR11 to XVR16, YVR16. The naming/numbering convention is the same as that disclosed for the object positions, except that “V” denotes that these are positions of the vehicle 105 rather than of the objects 1-6.

FIG. 1A is a non-limiting example of a second map 100, which is indicative of the second relative position of one or more objects, relative to vehicle 105.

Attention is now drawn to FIG. 1B, schematically illustrating an example generalized view 102 of object transmissions, in accordance with some embodiments of the presently disclosed subject matter.

The positioning system of vehicle 105 receives first information indicative of at one or more transmissions, associated with one or more objects 191, 192, 193, 195, 196, 197. In one example, objects 191-197 are vessels or other water-borne vehicles, or fixed objects located e.g. on the coast, and are equipped with e.g. AIS transponders 179. For simplicity of exposition, the only transponder shown in the figure is the one on vessel 191.

The first information in the transmission from each object/ship/vessel includes, in some examples:
one or more items of object identification information of the object. In some examples this object ID information comprises one or more of a MMSI (Maritime Mobile Service Identity), a name of the at least one object (e.g. “The Queen Mary”), or a call sign of the object. In the example of the figure, the transponders 179 broadcast the names Ship 1, Ship 2, Ship 3, Ship 5, Ship 6 and Ship7, correspondingly.
one or more items of object first position information associated the object. This object first position information is in some examples indicative of an absolute position of the at least one object. In the example of the figure, the transponders 179 broadcast the absolute locations (in some relevant reference frame), comprising e.g. two-dimensional coordinates X1, Y1, X2, Y2 . . . . X7, Y7. In some examples, these coordinates are Longitude and Latitude. In some examples, this position information is based on GNSS measurements (e.g. GPS measurements) performed by the ship/object 1, 2 using its associated GNSS receiver (not shown in the figure).
Information concerning the ship's course, e.g. Course over ground (COG)
Ship's speed, e.g. Speed over ground (SOG)
Time Stamp of the transmission

In some examples, vehicle 105 comprises, or is otherwise is associated with, a receiver 178 (see FIG. 1A), which is configured to receive the transmissions. In normal situations, e.g. where is no fraud involved, the reception of these signal broadcast by objects such as ships 192-197 indicates that vehicle 105 is in their vicinity.

The circles indicate that objects 192-197 are those for which first information is received by aircraft 105.

Note in the figure that Ship 7 197 is shown as a dashed line. This schematically indicates that its reported absolute position, e.g. of 2-D coordinates (X7, Y7), is considerably far away from that of most of the other vessels, and possibly from the known position of vehicle 105. One non-limiting example is an airplane 105 flying over the Mediterranean Sea, receiving positions (X1, Y1) through (X6, Y6) which are in the Mediterranean region, while position (X7, Y7) is a position in the middle of the Pacific Ocean. The transmission from object 197 is thus geographically unreasonable or illogical. In such a case, it may be apparent that receiver 178 is not receiving a transponder transmission from the Pacific, and thus the transmission of the information “object ID=Ship 7, first position information=X7, Y7” may be determined by vehicle 105 to be a faked or otherwise fraudulent transmission, e.g. transmitted by some local boat or other local object. Vehicle 105 may then ignore the data sent by 197 when determining vehicle position.

Also shown schematically is a feed of first information, e.g. AIS update information, from the Internet 190 (shown in the figure schematically as a cloud). In some examples, the vehicle 105 receives this internet feed via one or more satellites 198, which receive 199A the internet feed and relay 199B the feed to vehicles such as aircraft 105. In some examples, this a publicly available internet feed, e.g. from web sites such as https://www.marinetraffic.com/which receive constant updates and which sanity-check or otherwise verify their accuracy.

In one example, the internet feed information can be used to determine whether some of the first information sent by the various transponders 179 should be ignored. For example, if Ship 5 195 transmits that it is located in the western Mediterranean Sea, but the internet feed shows that Ship 5 has in fact been in the south Atlantic Ocean for the last 2 days, vehicle 105 is in some cases configured to consider this contradiction, and to determine that object 195 is in fact fraudulent, and that it is not in fact Ship 5. The vehicle/aircraft is in some examples configured to then ignore this AIS broadcast from 195, when determining vehicle 105 position.

Note that in some cases the internet feed includes analytics information which was performed by the particular internet site etc. As one non-limiting example, in some cases, the internet site pre-filters AIS transmissions that are indicative of unreasonable geographic locations, and does not list such ships. In addition, in some cases internet sources such as the web site https://www.marinetraffic.com/provide additional information associated with broadcasting ships, such as the type of ship, the ship's size (e.g. length and/or beam), the ship's direction (course) of travel, ship's speed, picture of ship, Time Stamp of the transmission, and route forecast, as non-limiting examples. Example uses of such data are disclosed further herein with reference to FIG. 2.

Note that although AIS broadcasts can include parameters such as type of vessel, ship length/beam, course, speed etc., in some examples certain ships do not broadcast all, or at least some, of this data. In such a case, the internet 190 feed can supplement the received AIS transmission, to provide such information.

Note also that in some examples, reception by the positioning system of object ID information is not required. However, this information provides at least certain example advantages, in cases where not all ships in the region are of sufficient trustworthiness. The object ID information can be utilized to determine a level of trustworthiness of one or more of the ships.

FIG. 1B is a non-limiting example of a second map 102, which is indicative of item(s) of first position information of one or more objects, e.g. of absolute position information.

Attention is now drawn to FIG. 2, schematically illustrating an example generalized view of a map overlay 200, in accordance with some embodiments of the presently disclosed subject matter. The maps 100 and 102 are shown as overlaid one on the other. For simplicity of exposition, it is assumed that position data is known only for the objects shown in the figure.

A computerized system can, for example, manipulate the maps so as to get the best match, between first objects 191-197 on first map 102, and second objects 1-6 on second map 100. Matching of geometric patterns, associated with the position information received from e.g. the AIS 179, 190 and from sensor/RADAR 177, is performed. In some non-limiting examples, the maps are overlayed so as to get a “best fit”, where a maximum possible number of objects from each map are close in position to a corresponding object on the other map. The figure shows one such result.

It is seen in the figure that objects 1 and 191 are in the same position, that objects 5 and 195 are in the same position, and that objects 6 and 196 are in the same position. This is indicated by the full or near-full overlap of the corresponding circles and squares. More generally, it is seen that objects 2 and 192 are in the same position within a distance 220, and that objects 3 and 193 are in the same position within a distance 230. If these distances 220 and 230 are within a defined tolerance, e.g. the differences are less than a defined threshold, the positions of 2 and 192, for example are taken to be the same. Therefore, the item of object first position information associated with first object 192 and the object relative second position of second object 2, are considered to be indicated of the same position. This is referred to herein also as a first matching, of an object second relative position, of a second object 2, with item(s) of object first position information, comprised in the first information, associated with a first object 192. The first matching in some implementations includes comparing first map 102 and second map 100.

Note that the defined tolerance is a function of the specific situation of aircraft 105 and of the vessels/ships/objects in its vicinity. In some examples, the defined tolerance has a value of 1-50 meters (m). In some examples, the defined tolerance has a value of 50-500 meters. In some examples, the defined tolerance has a value of 0.5-1 kilometers (km).

For example, if the object position information received via e.g. AIS and RADAR show that there are relatively few vessels in the area, and that they are comparatively far apart from each other, then a distance 220, 230 of 1 km may be sufficient to consider 2 and 192 the same position. Such a condition may apply in a comparatively “empty” portion of an ocean, away from the main traffic lanes and routes, where ship and boat traffic is sparse.

On the other hand, if the object position information received via e.g. AIS and RADAR show that there are relatively many vessels in the area, and that they are comparatively close to each other, then a shorter distance 220, 230 of e.g. 50 m may be required to consider 2 and 192 the same position. Such a condition may apply in a comparatively “densely populated”/“busy” portion of a body water, where ship and boat traffic is heavy and dense, e.g. in the main traffic lanes and routes, and/or in the vicinity of a busy port, or in a narrow region such a strait or channel where ships must be relatively close to each other.

In some examples, the values of this defined tolerance are configurable. In some examples these values are stored in a data store (disclosed further herein with referent to FIG. 3B), associated with vehicle 105, along with the conditions for using each tolerance value or range of values.

In some examples, the first matching of object positions derives absolute position information of second object(s). For example, if it is determined that second object 3 and first object 193 are in fact at the same location, and if the absolute first position of first object 193 is X3, Y3, then the computerized positioning system can determine that second object 3's position is also in fact X3, Y3. Similarly, the first matching can yield the determination that second object 1 has absolute position X1, Y1 associated with first object 191. In such a manner, in some cases the absolute positions of all of the matched first positions can be determined by the first matching.

Another matching can be performed, referred to herein also as second matching. Those objects whose positions match can be determined to be matching objects. For example, the system can determine, that since their respective positions have a first match, object 5 is in fact the same as object 195. If, for example, object 195 is “Ship 5”, based on the AIS information associated with it, then the second matching can determine that object 5, which was detected via RADAR is in fact Ship 5—despite the fact there was no any ID associated with the RADAR detection. That is, the object identification information of the matched second object is associated with the corresponding first object. Thus, each matched second object 1, 2, 5, can be set to constitute a corresponding object (referred to also as first object) 191, 192, 195.

Note that in the figure, objects 4 and 197 do not have matches. As indicated above with reference to FIG. 1B, the object 197 broadcast a location unreasonably far from the vehicle 105 and the other objects, its information was ignored, and it is not considered in the matching nor in the map overlay. In another example, object 197 is ignored because its broadcast absolute position information is inconsistent with the position for “Ship 7” received via the internet feed 199B, e.g. the two positions differ by more than a maximum allowed amount, e.g. a threshold difference (which in some examples is a configurable value, e.g. stored in a data store).

Object 4 was detected by the vehicle's sensors 177, e.g. RADAR, but no AIS information was received with object first position information that corresponds to 4's position. Thus object 4 is in some examples, considered by vehicle 105's associated positioning system, to be suspicious—e.g. a smuggler, a criminal vessel, a fishing vessel performing illegal fishing, or some other illegal vessel-one which is physically present on the water but which chooses to not broadcast AIS transmissions, for example in an attempt to evade detection. Another example of this is a refugee boat which does not broadcast AIS. Note that other cases of not broadcasting AIS exist. These include at least certain military ships, vessels that are not required by regulation to broadcast AIS, and cases where the ship's AIS equipment is malfunctioning.

In addition to possibly labeling object 4 as a suspicious object, the positioning system will not consider it, when determining vehicle 105's position.

In some examples, the derived absolute position of the vehicle 105 can be determined, based at least on the absolute position information X3, Y3 of the corresponding object(s) 193 and on the object(s) 3 second relative position(s) XR13, YR13. Taking for example objects 3 and 193, they have been second matched, and it is determined that they are the same object. The absolute position of aircraft 105 can be determined to be, conceptually (using vector arithmetic):

$$\begin{matrix}( Xv - abs - 3 , Yv - abs - 3 ) = ( X 3 , Y 3 ) - ( XR 13 , YR 13 ) \\ = ( X 3 , Y 3 ) + ( XVR 13 , YVR 13 )\end{matrix} \qquad ( 1 )$$

In this equation “v-abs” refers to absolute position of the Vehicle 105, and the “3” refers to a vehicle position calculated based on objects 3, 193.

Recall that, as shown above, relative positions X12, R12 of second objects such as 2 can be determined using range 122 and angle B.

When determining the aircraft's 105 absolute position based e.g. on map overlay 200, several considerations are possible. In some examples, in order to help determine which ships should be used for the vehicle-positioning task, the positioning system maintains a database or a list of various ship identifications, each associated with a quality metric or score, for example indicative of the reliability or trustworthiness of the AIS data broadcast by that ship. In one non-limiting example, the metric is at least partly based on how well-known and trustworthy the object is. In one example, a well-known ocean liner has a metric of 10, an oil tanker with a very well-defined regular route receives a metric of 8 or 9, a small fishing vessel (or other craft not a priori known) has a metric of 1 or 2, etc. Similarly, in some examples an object such as object 4, which has no matching with AIS information, is not to be used for the calculation in any situation, and the object assigned a metric of 0.

Note also that in some cases the system does not know a priori the vessel type for each vessel, that is that data and the associated quality data is not pre-stored for that vessel. In some such examples, the system makes use of “type of vessel” information (e.g. “oil tanker”) provided in the AIS transmission, and/or in the internet 190 feed.

The quality metric is referred to herein also as an identification quality metric.

In some examples, the identification quality metric is based at least in part on a level of geographic reasonableness associated with a corresponding item of object first position information of an object. As one example, indicated above, since Ship 7 197 broadcast that it is in the Pacific Ocean, while aircraft 105 is flying over the Mediterranean, there is a “severe” or serious lack of geographic reasonableness, and its quality score may be set to 0, such that object 197 is ignored. As another example, if Ship 7 197 broadcast that it is in the Mediterranean, while the internet feed is tracking it over time as currently travelling in the Arctic Ocean, again there is a severe geographic unreasonableness, and its quality score may be set to 0, such that object 197 is ignored.

In still another example, the datastore associated with the positioning system stores the regular known routes of ships such as Oil Tanker 2. If the Tanker 2 broadcasts that it is a few hundred km away from its well-known route, or in some cases several dozen km away, and/or if the RADAR data detects this deviation from the standard route, then the quality metric associated with Tanker 2 can be reduced from e.g. 8 to e.g. 5 or 6, so as to indicate a lower level of trustworthiness, that is one that indicates a comparatively lower level or degree of certainty that the broadcasting object is indeed Tanker 2.

The above scoring system is presented as a non-limiting example, for exposition purposes only.

Once quality metrics are determined for one or more of the first objects, in some examples the positioning method can make use of them. In one example, one object 193 is known to be very trustworthy (e.g. quality metric=10). If relative position XR13, YR13 has been measured, object 193 can be selected, and can be used alone for the determination. An example of this is that object 193 broadcast that it is a well-known ocean liner such as the Queen Elizabeth, and the internet feed confirms this information. Since there is little reason to doubt the veracity of object 193, the system can apply equation (1), and can thus determine aircraft 105's position based solely on AIS information from one ship.

In another example, the system selects a plurality of objects 192, 193, 195 to be utilized when determining the derived position of the vehicle 105. In some examples the selection is based at least on the quality metric. In such a case, these objects with higher quality metrics have the priority for being used in the calculation, and lower-quality-metric objects are used only if there are insufficient higher-quality (i.e. higher trustworthiness) ships/objects available. In some other examples, the quality metric is a threshold for use. That is, it in some cases ships with a metric below 9 are not used at all, even if more trustworthy ships are not in the vicinity. In such a case, the aircraft may increase its altitude, and/or to move to another region, as exemplified further herein, in an attempt to search for higher-quality metric ships.

The above examples are non-limiting examples of selecting which ships/objects to use in the calculation of the vehicle 105 position.

It should be noted here that there are other cases where positioning is performed using only one or two ships. For example, the aircraft 105 is flying over a fairly empty area of the ocean, and only one ship 193, 3 is detected and sends AIS transmissions. Having no other options, the single ship 193, 3 is used for the aircraft position calculation.

In some other examples, by contrast, the derivation of the aircraft/vehicle's 105 position Xv-abs, Yv-abs utilizes multiple ships/vessels/objects 1, 2, 3, 191,192, 193, and not only one ship. In the example of FIG. 2, each object can be used separately to determine vehicle position. For example, equation (1) above can provide the calculated value (Xv-abs-3, Yv-abs-3). Another calculated value (Xv-abs-2, Yv-abs-2), based on object 2, 192, can use an equation similar to (1), but one based on (X2, Y2) and (XR12, YR12). In a similar manner, in the example of the figure, absolute values of aircraft 105 position can be determined based on each of the vessels 1, 2, 3,5, 6.

In some examples, the final value Xv-abs, Yv-abs of the derived vehicle 105 position is computed based on the values (Xv-abs-2, Yv-abs-2), (Xv-abs-3, Yv-abs-3) etc. determined based on each ship/object 1, 2, 3, 5, 6. In one non-limiting example, an averaging of the multiple determined vehicle position values is performed. In some examples, such averaging of values based on multiple measurements and data points can provide a more accurate final value of the vehicle 105 position.

In some other examples, application of weights can provide a more accurate final value of position than a simple averaging which considers all of the objects as contributing equally to the position calculation. In some such examples, a weighting is assigned to each calculated position (Xv-abs-3, Yv-abs-3) etc., and the final value of the derived position is determined based on the weighted positions, e.g. using a weighted averaging. In some examples, the weighting associated with each position calculation is based on an object weight associated with each object 1, 2, 3. In some examples, the object weight is assigned to the object based on the quality metric determined for that object. Thus, for example, the position derived based on data of the ocean liner is weighted more highly than is the position derived based on the small fishing boat, when determining the final value Xv-abs, Yv-abs.

In some examples, a combination of priorities and weights are used. For example, 30 ships are both detected using the RADAR and have associated AIS transmission. However, only 5 of the 30 are chosen to be used in the calculation, based on the quality metric and the needs of the particular calculation scenario. Each of these 5 ships has an associated respective object weight, and the derived position is based on the 5 corresponding weighted position calculations.

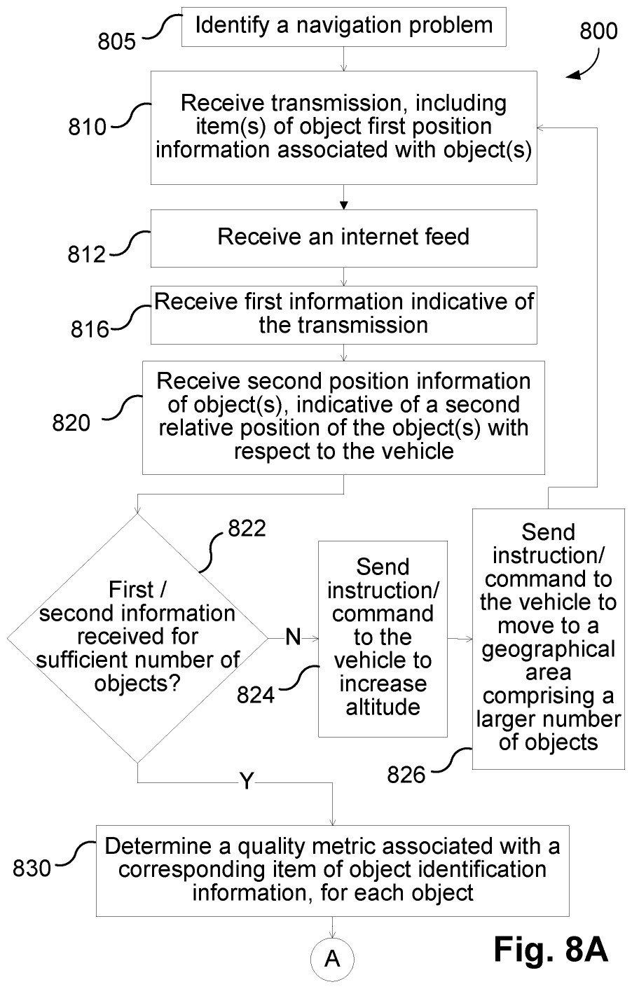

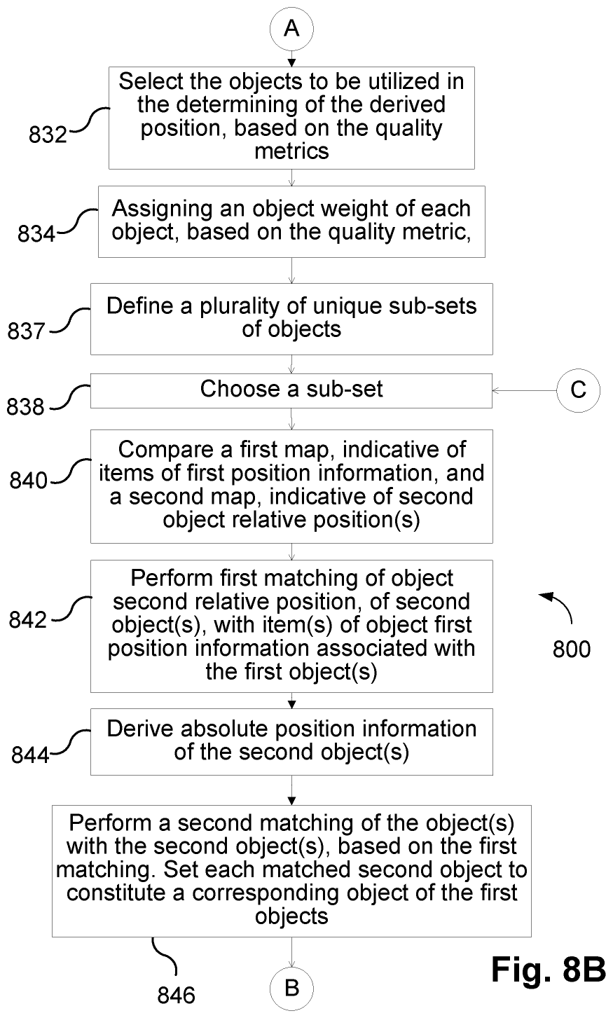

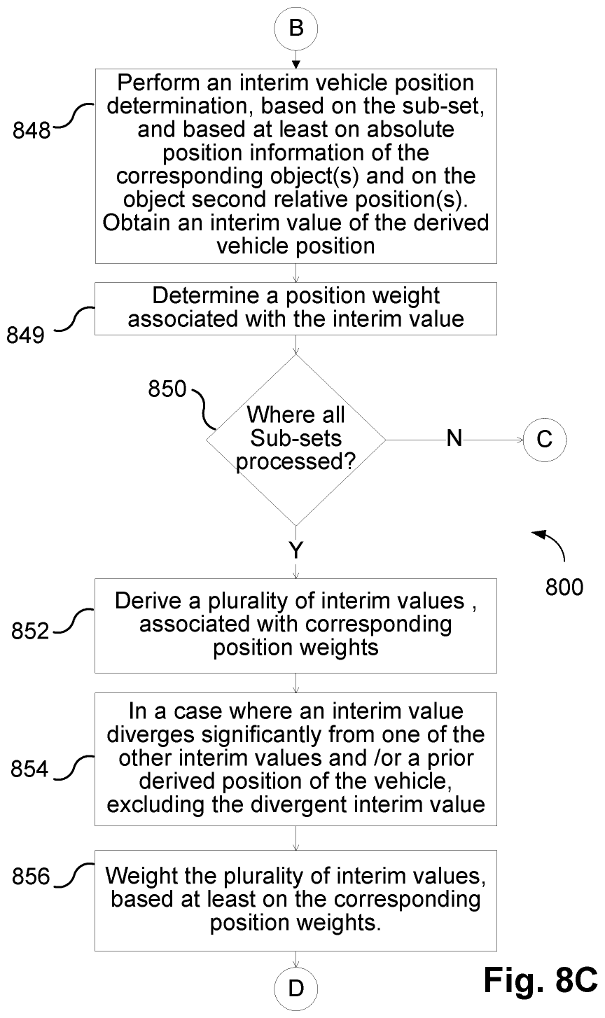

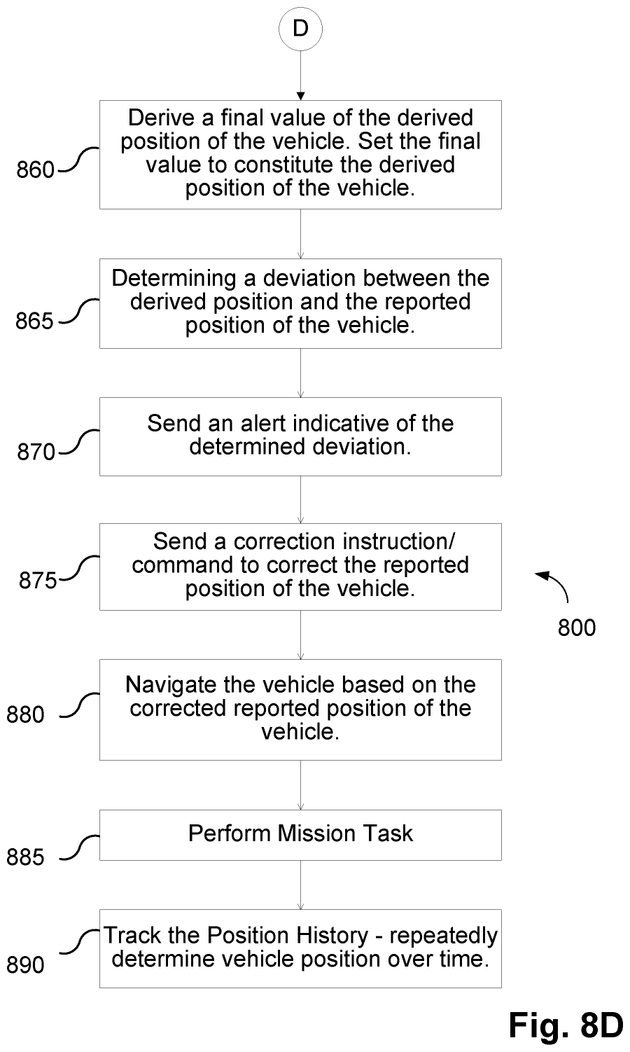

Another example implementation of the aircraft 105 position calculation, based on using multiple sub-sets of the set of ships 1, 2, 3, 5, 6, is disclosed further herein, with reference to FIG. 8.

In some examples, it is desirable for the aircraft to “see” (i.e. to be able to detect with the sensors, and to receive sufficient AIS information concerning), a sufficient number of ships. This may be done so as to not be vulnerable to spoofing of certain AIS information, and to possible GNSS disruptions (spoofing, jamming etc.) which may cause a ship's 192 AIS transponder 179 to transmit e.g. a GPS-based position which is based on incorrect GPS readings.

Note that in some examples, the area of GNSS disruption due to e.g. spoofing or jamming is of a size smaller than the area from which the vehicle 105 can receive AIS transmissions. In one example, GNSS disruption covers an area of up to several kilometers (km), while the aircraft, flying at a relatively high altitude, can receive AIS transmissions from a distance of e.g. tens of km, e.g. up to around 100 km radius. Thus, if AIS transmissions from a sufficient number of ships are received, the vehicle can, using statistical methods, derive its correct self-position, despite the fact that some of these ships are transmitting incorrect position due to e.g. GNSS spoofing, or are transmitting with no position information due to e.g. GNSS jamming.

In some cases, the position information broadcast by the “outlier” ships is excluded from the calculation. For example, based on transmissions from 22 ships, the vehicle's position is determined as X9, Y9, within a few hundred meters, while three other ships provide transmissions which would result in a vehicle position that is 30 km away from X9, Y9. These three ships are ignored, for the calculation.

Note also that, in cases where GPS interference is known and anticipated, e.g. as shown in the web page https://safety4sea.com/areas-with-rising-gps-interference-and-jamming-incidents/, the system can be configured to choose a larger number of AIS transmissions for use in the position calculation, and can be configured to increase altitude if necessary to find this larger number, as compared to a smaller number of transmissions required when flying in areas with no a priori expectation of GNSS interference. In some examples, the system stores a database/list of the problem areas, and/or gets feeds of updates to the list of problem areas, and chooses the large number of AIS transmissions based on this information.

Disclosure of some additional example implementation options is herein provided.

In some examples of the use of RADAR 389, when a blip is detected, the RADAR aperture angle can be changed, so as to detect the blip as a larger image, and to be able to estimate its size. Thus, it can be distinguished whether e.g. object 2 is a small yacht or an ocean liner. This information can be utilized when performing first matching of RADAR-detected object 2 with AIS-broadcasting objects such as 191, 192. Note that if the size information was not provided in the AIS broadcast, it can sometimes be provided by the internet 190 feed. The RADAR-determined size can be compared to the AIS-provided size, in an attempt to match AIS and RADAR data.

Note that in some other examples, e.g. disclosed with reference to FIGS. 5 and 6, the positioning system is configured with cameras or other image sensors. In some such cases, the system can utilize pictures of the ships, provided in the internet 190 feed. Image processing can be performed on the captured images, in an attempt to match the captured image to the received pictures of the ships associated with the AIS data. In some examples, the image comparison utilizes machine learning.

In some examples of first matching, e.g. as disclosed with reference to FIG. 2, use is made of matching of geometric patterns or formations, in the determining of aircraft 105 position. This is an example of geo-registration. For example, the system is configured, for a particular scenario, to position the aircraft based on Ship 3, a trustworthy ocean liner. AIS reports three ships whose positions form roughly an isosceles triangle of certain dimensions, with apex pointing west. The westmost ship in this AIS information is Ship 3. Also the RADAR pattern shows an isosceles triangle, of similar size, with apex pointing west. The positioning system 310 can thus know that the two triangles correspond, and thus that the westmost of these RADAR-detected objects is Ship 3. The system can then use Ship 3 for vehicle self-positioning. In some cases, the RADAR 389 is then focused on Ship 3, to determine its position accurately and to confirm its size.

A triangle is only non-limiting example of a geometric pattern. In another illustrative example, the AIS and RADAR data both show a “convoy” of 5 ships in a particular formation, roughly in a row or a line, and the second ship in the line is trustworthy Ship 3.

Note that performing geo-registration using geometric patterns enables, in some examples, matching of AIS and RADAR data even in cases where the RADAR is not capable of e.g. determining the size of the object, and thus cannot use object size to help identify the object. In one example, the particular RADAR 389 on aircraft 105 is not capable of identifying ocean liner Ship 3 based on the size of the RADAR blip. However, using geo-registration, the system is able to determine that the blip at the apex of the triangle is Ship 3, by comparison with the ship's position in the triangle of AIS-based positions.

In some examples, the RADAR is set to a relatively narrow aperture angle, to see at a greater distance, in an attempt to detect an expected ship (e.g. Ship 3 which is reported by AIS as being located at X3, Y3). Once the ship is detected, the positioning system 310 may want to verify that it, and not some other nearby object, is indeed Ship 3. Therefore the RADAR angle can be increased, to see a wider field, so as to detect any possible nearby objects and to aid in the decision which is Ship 3. Another option is to instead, or to additionally, rotate the direction of the RADAR, so as to look at a region somewhat to the left/right of the originally viewed region, and to gather additional data.

Note that in some examples, the system is configured to scan a particular area using multiple aperture angles, so as to increase the amount of data collected and to improve the decision.

Note that in some examples, additional matching can supplement, or in some cases can be used instead of, the matching of geometric formations or patterns. In one illustrative example, AIS data indicates a equilateral triangle with length of each side equal to 5 km, with apex to the West. However, the RADAR data shows two such triangles, and the system needs to decide which one in fact corresponds to the AIS data.

If the AIS data (via the transponder 179 transmission, and/or via the internet 190 feed) includes direction data of ships, e.g. the course of a ship, the system could try to match this data, as provided by the sensors and by AIS. Continuing this example, the AIS indicates that all three ships in the triangle pattern are traveling North. The RADAR data shows that in one triangle three objects are indeed all traveling North, while in the second triangle one is traveling East and two are traveling Southwest. The system determines that the directions associated with ships of the second triangle and of the AIS-based triangle are not close enough (e.g. using a threshold parameter of a certain number of degrees). The system eliminates the second triangle as a candidate for the match, and it determines that the first triangle is the one that corresponds to the AIS-based geometric pattern.

Similarly, if the AIS data (via the transponder 179 transmission, and/or via the internet 190 feed) includes speed data of ships, the matching between AIS and RADAR data can also be performed at least partly based on the speed. In one illustrative example, the AIS shows a ship traveling at 30 knots, but the RADAR data for a ship in that vicinity shows that ship traveling at only 10 knots. The system determines that the two speeds are not close enough (e.g. using a threshold parameter), and thus these two ships do not match each other.

Note also that matching of AIS and RADAR data, based at least partly on speed and direction, can be performed also on individual ships, and not only on geometric patterns/formations.

In these examples, the geometric patterns/formations are referred to herein also as anchor spatial patterns or anchor spatial formations. The points on these patterns, representing ship locations known via e.g. AIS, are referred to herein also as reference points. The AIS information can make each such ship serve as a reference point, for georeferencing the picture obtained by e.g. the RADAR, in terms of determining the absolute position of objects detected by the RADAR. This georeferencing in some examples is based on the geo-registration of the RADAR and AIS points based on the matching of the geometric patterns obtained using the two technologies.

Note also that in some examples AIS time stamp information can be utilized in the matching process. In this case, AIS data (via the transponder 179 transmission, and/or via the internet 190 feed) includes the timestamp of the ship's transmission. In one illustrative example, the RADAR shows an object 2 at X9, Y9. The AIS information shows no object near that location, but shows a ship 192 with position X10, Y10, somewhat further away. However, the AIS information is 10 minutes old. If, for example, the AIS information included also ship's 192 direction and speed, the positioning system can estimate that now, 10 minutes later, the ship 192 should have moved, with a sufficiently high probability, from X10, Y10 to a new location that is close to X9, Y9 within the defined tolerance. The system therefore decides to match the RADAR and the AIS objects.

Note also that in some examples AIS route forecast information can be utilized in the matching process. In this case, AIS data, e.g. via the internet 190 feed) includes the the ship's route forecast. See such information e.g. at the web site https://www.marinetraffic.com/. In one illustrative example, the RADAR shows an object 2 at X9, Y9. The AIS information shows no object near that location, but shows a ship 192 with position X10, Y10, somewhat further away. The time stamp of the AIS information is 10 minutes ago. In the example, the AIS information includes a route forecast. Based on the route forecast, it is determined with a sufficiently high probability that the forecasted route would bring this ship to approximately X9, Y9 since 10 minutes ago. The system decides to match the RADAR and the AIS objects.

Note also that in some examples, the positioning method makes use of some or all of this AIS information, and/or other AIS information not disclosed above, in any combination. Each piece of information can increase or decrease the probability that a first point 193 on an AIS “map” 102, and a second point 3 on a sensor “map” 100, are in fact the same ship at the same location.

Note that FIG. 2 illustrates the non-limiting example of a map overlay, for matching first and second position information, and matching first and second objects, based on comparing first map 102 and second map 100. In other examples, other methods, e.g. known per se mathematical methods, can be utilized for this purpose.

Note also, that in some examples where positioning is performed based on only one trustworthy object 1, 191, a map overlay method is not required.

As indicated above, in some examples the derived position of airplane 105, determined using the methods disclosed with reference to FIGS. 1-2, is compared to the position reported e.g. by GNSS receiver 185. If the difference is greater than a pre-defined amount, e.g. above a defined threshold, it can be determined that there is a GNSS problem, and the reported position Xv-rep, Yv-rep of the airplane can be corrected, based on the derived position. The airplane 105 now knows its correct position, despite the GNSS problem. The navigation in some cases is based on this this corrected position.

Note also, that in some examples, the processing circuitry of the positioning system is configured to perform one or more repetitions of the method disclosed with reference to FIGS. 1-2. For example, every second, number of seconds, or fractions of a second, the process can be repeated. This can in some cases enabling a tracking of the corrected reported position, thereby e.g. enabling improved navigation. For example, if the correct position at time Tl has been determined, based on GNSS and/or on the presently disclosed subject matter, then the positioning system will not accept, 10 seconds later, a position determination that indicates that the airplane flew 50 km in the last 10 seconds, since such a situation is unreasonable. That is, the determination of the current position of the vehicle is in such a case based at least partly on the vehicle's previously determined position(s).

In some examples, the vehicle 105's route of travel is planned a priori, or is changed e.g. in real time or near-real time, based on the first information, e.g. AIS information. In some examples these are preformed by route planning/optimization module 331 disclosed below with reference to FIG. 3B. In some examples, this is performed in an automated fashion.

In one example, the initial flight route, including choice of waypoints, takes as one consideration the “navigability” of the particular route, that is whether navigation can be performed on this route in a reliable manner, even in the face of possible GNSS disruptions. For example, the module 331 receives the internet 190 feed updates of AIS information, and/or information on known historical routes of e.g. tankers and other ships with relatively fixed and well-known routes. The module constructs the route such it will pass over areas where there is a sufficient density of AIS transmitters 179, e.g. associated by ships/objects 191 having the desired quality metric. In such a manner, the flight route will be optimized, in that the route will pass in the vicinity of reliable AIS transmitters, and thus self-positioning of the vehicle 105 will be possible even if there are GNSS disruptions.

In another example, module 331 performs, in real time or near real time, recalculations of routes and modifications of routes during the vehicle 105 flight. If the AIS receiver 178 receives AIS information indicative of an insufficient number of ships, or of reliable ships, in the vicinity, and/or in the region where the vehicle is planned to travel, the module may look at received AIS information, and may plan or determine a new route, with new waypoints, one which is expected to provide better AIS “coverage”, that is to travel in the vicinity of the requisite number and quality of AIS transmissions. Such a re-route can in some cases be a more optimized one, in that it can facilitate an improved probability of reliable navigation in face of possible GNSS disruptions. Note that in some examples, the module considers also (or instead) the internet 190 updates of AIS data. Further disclosure of this route modification is provided further herein with reference to blocks 822, 824 and 826 of FIG. 8.

In one example, the initial flight route planning, and/or the recalculations of routes during vehicle travel, utilize advisories/alerts concerning known or anticipated areas of

GNSS disruption. See e.g. the web page https://safety4sea.com/areas-with-rising-gps-interference-and-jamming-incidents/. The system can be configured to receive this advisory information, and in some cases to store it for future reference. The route planning module 331 can be configured to particularly focus on these known areas, and to plan routes such that, at least in those areas, known for problematic GNSS, the routes pass through the vicinity of the requisite number and quality of AIS transmissions.

In another example, the initial flight route planning, and/or the recalculations of routes during vehicle travel, utilize route forecast information. In this case, AIS data, e.g. via the internet 190 feed) includes the ship's route forecast. See such information e.g. at the web site https://www.marinetraffic.com/. The route planning can consider not only current AIS-based positions of ships to server as anchors, but also future estimated positions based on the ships' route forecasts.

Note that the module 331 can use some or all of these information sources, and considerations, when planning and/or modifying the routes.

FIGS. 3A-3B below disclose a typical example system architecture for implementing this localization method. FIGS. 1A-2 and FIGS. 4-8 below illustrate example techniques for determining position Xv-abs, Yv-abs of aircraft/vehicle 105. FIGS. 8A-8D below provide detailed example flows of the computerized positioning method.

Attention is now drawn to FIG. 3A, illustrating a generalized example schematic diagram of a vehicle positioning solution 300, in accordance with some embodiments of the presently disclosed subject matter. The components disclosed with reference to FIG. 3A, and with reference to FIG. 3B disclosed further herein, can in some examples be used to perform positioning/localizations actions and methods as disclosed with reference to FIGS. 1-2, and further herein with reference to FIGS. 4-8.

In some examples, vehicle 105, e.g. an airplane or other aircraft, e.g. a UAV, comprises a user interface (UI) 392, associated with and used by human operator 391. Examples of human operator 391 include aircraft crew members such as pilot, co-pilot or navigator. In other examples, the UI 392 and the human operator 391 are located externally to the vehicle 105, e.g. at a ground station (not shown), for example at one connected to vehicle 105 by external system 395.

In some examples, vehicle 105 comprises a computerized positioning system 310. In some examples, this system performs one or more of the methods of FIGS. 1-2, 4-8. A non-limiting example schematic diagram of system 310 is disclosed further herein with reference to FIG. 3B.

In some examples, vehicle 105 comprises a navigation/guidance system 360. In some examples, this system navigates and guides the movement of vehicle 105. Note that in some examples systems 310 and 360 are parts of the same system, or one comprises the other.

In some examples, vehicle 105 comprises GNSS receiver 185. Examples of the GNSS receiver's function for determining vehicle 105 position are disclosed, for example, with reference to FIG. 1A.

In some examples, vehicle 105 comprises RADAR 389. This is one example of sensor 177. Examples of the RADAR's function for determining relative position of objects 1, 2 are disclosed, for example, with reference to FIGS. 1A, 2.

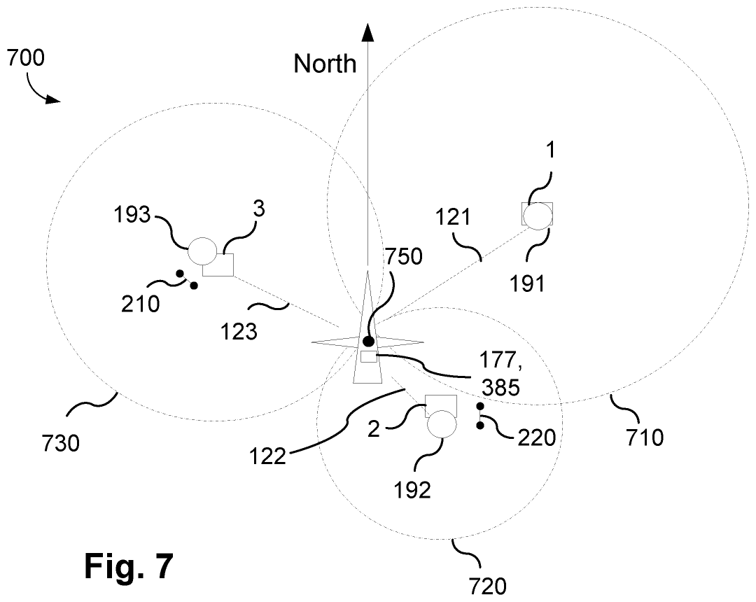

In some examples, vehicle 105 comprises one or more range finders 385. This is another example of sensor 177. Examples of the range finder's function for determining relative position of objects 1, 2 are disclosed, for example, with reference to FIGS. 5 and 7 further herein.

In some examples, vehicle 105 comprises one or more cameras or other image sensors 375, 377, 370. Camera #1 375 and camera #2 377 are in some examples one or more fixed cameras, mounted in a fixed manner to a particular part of the vehicle, and with a particular viewing angle. The particular example of camera 370 is a camera mounted e.g. on a gimbal, such that its view angle can be changed. Examples of the cameras' function for determining relative position of objects 1, 2 are disclosed, for example, with reference to FIGS. 5 and 6 further herein.

In some examples, vehicle 105 comprises a receiver 178. Receiver 178 configured for receiving the transmissions indicative of first information of objects, e.g. as disclosed with reference to FIGS. 1A and 2. In some non-limiting examples, the receiver is an AIS receiver 178.

In some examples vehicle 105 comprises an internet interface 388, configured for communication 199B with the internet 190. Interface 388, in some cases, facilitates receival of the internet feed 199A, 199B of the updates of first information, e.g. AIS internet updates. As disclosed with reference to FIG. 1B, in some examples the feed utilizes satellite(s) 198, and internet interface 388 is configured for communication with this satellite(s). In some examples, interface 388 utilizes known communications interfaces and technologies, such as wireless technologies, e.g. those known in the art. Example uses of the internet feed are disclosed with reference to FIGS. 1B, 2.

Note that the internet 190 and the relay satellite 199, not shown in this figure for simplicity of exposition, are in some cases part of the positioning solution 300.

In some examples, vehicle 105 comprises an external interface 390. Interface 390 is configured for one-way or two-way communication 397 with one or more external systems 395, which are located eternal to the vehicle/aircraft 105. In some examples, interface 388 utilizes known communications interfaces and technologies, such as wireless technologies, e.g. those known in the art. Example functions of external systems 395 and external interface 390 are disclosed with reference to FIG. 8 further herein. For example, interface 390 can be used to send alerts, commands and/or instructions to external system(s) 395.

Note that in some examples external interface 390 and internet interface 388 are the same, or alternatively they share at least some components and technologies.

Attention is now drawn to FIG. 3B, schematically illustrating a generalized example schematic diagram of computerized positioning system 310, in accordance with some embodiments of the presently disclosed subject matter. The figure provides additional detail of the example computerized positioning system 310 disclosed with reference to FIG. 3A.

In some examples, computerized positioning system 310 includes a computer. It may, by way of non-limiting example, comprise a processing circuitry 312. This processing circuitry may comprise a processor 314 and a memory 317. This processing circuitry 312 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 312 may be a computer(s) specially constructed for the desired purposes.

Processor 314 may comprise, in some examples, at least one or more functional modules. In some examples it may perform at least functions, such as those disclosed with reference to FIGS. 1-2 and 4-8.

In some examples, processor 314 comprises sensor input module 322. In some examples, this module is operatively coupled to one or more of sensors 177, 380. 385, 370, 375, 377. In some examples, this module is configured to capture position sensor data, to be used in determining the relative position of the vehicle 105 with respect to the “second” vessels/objects 1, 2, 3, 4, 5, 6.

In some examples, processor 314 comprises transmission input module 324. In some examples, this module is operatively coupled to one or more of receivers 178, e.g. AIS receiver(s) 178. Thus, in some examples the input module 324 is referred to herein also as AIS input module 324. In some examples, this module is configured to receive first information, associated with the “first” vessels/objects 191, 192, 193, 195, 196, 197, e.g. from AIS transponders. In some examples, this first information includes including in some examples first position information and object ID information. In some examples, this module is coupled to internet interface 388, so as to receive the internet feeds of e.g. updated AIS information.

In some examples, processor 314 comprises objects prioritization and weighting module 326. In some examples, this module is configured to assign quality metrics to first objects 192, 193 (e.g. based on the reliability/trustworthiness of their identification), to assign prioritizations for each object's use in vehicle 105 position calculations, and/or to assign object weights for each object, which will be used to weight the contributions of each object to the vehicle position calculations. Examples of these functions are disclosed herein with reference to FIGS. 2 and 8.

In some examples, processor 314 comprises map overlay module 330, referred to herein also as position comparison module 330 and map comparison module 330. In some examples, this module is configured to perform first matching of object positions, e.g. based on items of object first position information, and on the object relative second position(s). In some examples, this module also performs second matching of e.g. second objects 2 and first objects 192. In some examples, this module performs comparisons for first maps 102 and second maps 100, e.g. using map overlay. In some examples, this module also derives final values of vehicle 105 position, e.g. based on weighting of position calculations. Examples of these functions are disclosed herein with reference to e.g. FIG. 2.

In some examples, processor 314 comprises final determination module 335, referred to herein also as aggregation module 335. In some examples, this module is configured to group the objects 1, 2, 3, 191,192, 193 into multiple sub-sets, to have the map overlay module 330 perform position calculations for each sub-set, and to aggregate these calculations so as to derive a final value of the position Xv-abs, Yv-abs of the vehicle 105. Examples of these functions are disclosed herein with reference to e.g. FIG. 8.

In some examples, processor 314 comprises deviation calculation module 340. In some examples, this module is configured to calculate deviation of the derived vehicle position, obtained using the method of the presently disclosed subject matter, and the reported position obtained from e.g. the GNSS receiver 105. Examples of these functions are disclosed herein with reference to FIGS. 2 and 8.

In some examples, processor 314 comprises position correction module 342. In some examples, this module is configured to correct the reported position Xv-rep, Yv-rep, if a sufficiently high deviation has been determined. Examples of these functions are disclosed herein with reference to e.g. FIGS. 2 and 8.

In some examples, processor 314 comprises alert module 344. In some examples, this module is configured to send alerts, concerning the deviation between derived and reported positions. Examples of these functions are disclosed herein with reference to e.g. FIG. 8.

In some examples, processor 314 comprises instructions/commands module 346. In some examples, this module is configured to send instructions, and/or commands, for correction of the reported positions, e.g. so as to improve navigation. Examples of these functions are disclosed herein with reference to e.g. FIG. 8.

In some examples, processor 314 comprises position history module 333. In some examples, this module is configured to track the position of the aircraft/vehicle 105 over time, e.g. as transmissions of first information are continually received, and as sensors 177 continually detect vessels/objects 1, 2. The module thus maintains a history of the positions of vehicle 105. Examples of these functions are disclosed herein with reference to e.g. FIGS. 2 and 8.

In some examples, processor 314 comprises route planning/optimization module 331. In some examples, this module is configured to plan routes based on transmission information (e.g. AIS), and/or to optimize and reconfigure routes during the flight/travel of vehicle 105. In some examples, this module functions in an automatic and autonomous manner, in real time. Examples of these functions are disclosed herein with reference to e.g. FIGS. 2 and 8.

In some examples, processor 314 comprises mission module 348. In some examples, this module is configured to perform the particular mission which is assigned to aircraft/vehicle 105. One non-limiting of such an example is a patrol mission. Examples of these functions are disclosed herein with reference to e.g. FIGS. 4 and 8. In some examples, memory 317 of processing circuitry 312 is configured to store data associated with the calculations and determinations performed by processor 314. For example, memory 317 can store received first information, measured relative second positions, maps and map overlays, calculated positions, calculated position deviations, previous positions (e.g. for tracking purposes), determined state of the GNSS system (e.g. functioning or disrupted) etc.

In some examples, computerized positioning system 310 comprises a database or other data storage 319. In some examples, storage 319 stores data that is relatively more persistent than the data stored in memory 317. Examples of data that is stored in data store 319 include ID information for vessels, quality metrics for vessels, weights and priorities of vessels, and known routes and/or locations of certain vessels.

The example of FIG. 3B is non-limiting. In other examples, other divisions of data storage between storage 319 and memory 317 may exist. For example, in some examples the maps 100, 102 are stored in storage 319. Note also that in some examples data store 317 is separate from computerized positioning system 310.

In some examples, some or all of the components of computerized positioning system 310 are comprised in the aircraft or other vehicle 105. In some examples, at least some of the components of computerized positioning system 310 are comprised in one or more external systems 395, which are operatively coupled to the at least one movable object, e.g. via external interface 390. For example, many of the calculations of positions can be performed external to the vehicle, in some cases.

FIG. 3 illustrates only a general schematic of the system architecture, describing, by way of non-limiting example, certain aspects of the presently disclosed subject matter in an informative manner, merely for clarity of explanation. It will be understood that that the teachings of the presently disclosed subject matter are not bound by what is described with reference to FIG. 3.

Only certain components are shown, as needed, to exemplify the presently disclosed subject matter. Other components and sub-components, not shown, may exist. Systems such as those described with respect to the non-limiting examples of FIG. 3 may be capable of performing all, some, or part of the methods disclosed herein.

Each system component and module in FIG. 3 can be made up of any combination of software, hardware and/or firmware, as relevant, executed on a suitable device or devices, which perform the functions as defined and explained herein. The hardware can be digital and/or analog.

Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIG. 3. To provide one non-limiting example of this, in some examples, deviation calculation module 340 and position correction module 342 are combined. Similarly, in some examples, map overlay module 330 and final determination module 335 are combined. Similarly, in some examples, interfaces 388 and 390, or cameras 370 and 375 or 377, are the same. Similarly, in some examples, there may be separate mission modules 348, each configured to perform different missions. Similarly, in some examples, separate instances of sensor input module 322 exist, to support each different type of sensor 177.

One or more of these components and modules can be centralized in one location, or dispersed and distributed over more than one location, as is relevant.

Each component in FIG. 3 may represent a plurality of the particular component, possibly in a distributed architecture, which are adapted to independently and/or cooperatively operate to process various data and electrical inputs, and for enabling operations related to positioning of the aircraft or other vehicle 105. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

Communication between the various components of the systems of FIGS. 3, in cases where they are not located entirely in one location or in one physical component, can be realized by any signaling system or communication components, modules, protocols, software languages and drive signals, and can be wired and/or wireless, as appropriate.

At least some example advantages of a system such as disclosed with reference to FIG. 3 are apparent. In situations of navigation on or over water, where there are no fixed land-based landmarks available, the vehicle 105 can use the ships/boats vessels 1, 2, 191, 192 as landmarks, i.e. as anchor points for positioning. The system can be used as a backup or supplementary or alternative positioning system, relative to the GNSS systems which are typically used, to aid in navigation of the vehicle 105. The navigation in some cases becomes immune to GNSS disruption, or at least becomes less dependent on GNSS, since the estimation of the vehicle's position will not drift in a case of GNSS disruption—as long as there are, for example, trustworthy vessels or other objects, whose AIS (for example) information can be trusted.

In some examples, adding e.g. a RADAR 389, and/or other sensors disclosed further herein, and a receiver such as an AIS receiver 178, to the existing aircraft 105, and adding software such as the modules disclosed in FIG. 3B, e.g. as a hardware/software retrofit, can enable this functionality in existing aircraft and other vehicles 105. Note that although AIS is not designed for the purpose of locating/localizing/positioning aircraft/vehicles that receive AIS transmissions, the presently disclosed subject matter provides a way of using such technologies for such a positioning purpose.

Note also, that in the comparatively rare case of very few ships being detected by e.g. the RADAR and broadcasting e.g. AIS, and if it is not possible to trust a sufficient number of these ships, the navigation may rely on the INS accuracy until a sufficient number of ships are identified. In some cases, three ships are sufficient for navigation, if they are not too close to each other.

In addition, use of multiple AIS transmissions (by multiple ships) for the position calculation, and also giving preference/weighting for the more-reliable trustworthy ships when calculating, increases the accuracy of the calculation.

Also, use of hardened AIS, e.g. using known methods, can make use of AIS an even more reliable tool for positioning, compared to e.g. use of a particular GNSS of a particular technology. For example, transceiver quality is improving, which are less sensitive to GNSS interference. Some new models receive signals of several GNSS technologies, e.g. GPS and Galileo, in some cases operating at different frequencies. Thus, if one frequency is interfered with, location-related signals can still be captured, and the AIS transponder can report a correct location. It is noted that the hardening abilities of AIS are improving over time.

Additionally, the obtaining of an AIS map from the internet 190, or from the internet as a supplement to the aircraft's AIS receiver 178, can in some examples improve the algorithm, in at least the following ways. In some cases, the internet provides an initial filtering/screening of reputable ships, which can serve as better landmarks. Also, the internet feed helps filter out illogical values, since the feed is based on a tracking of the ship over time. Although in some cases the internet information is delayed, relative to real time, ships/boats typically travel much slower than aircraft, and thus this delay in at least some cases does not have adverse effects on the positioning method.

Attention is now drawn to FIG. 4, schematically illustrating an example generalized view 400 of a patrol, in accordance with some embodiments of the presently disclosed subject matter. The patrol mission 400 disclosed with reference to this FIG. 4 is one non-limiting example of a mission performed by vehicle 105, utilizing in some examples mission module 348. In some examples, this mission is performed by a patrol aircraft 105, e.g. a marine patrol aircraft. In some examples, aircraft 105 is manned, while in others it is unmanned, e.g. it is a UAV.

Using e.g. RADAR 389, the patrol aircraft can survey a large maritime area 410, e.g. with a radius in the range of 100 miles. In some examples, the patrol aircraft 105 is also equipped with a receiver such as an AIS receiver 178, to receive transmissions of first information. In addition, in some cases, the aircraft also receives internet 190 feeds of AIS updates. (The internet feed is not shown in this figure, for clarity of exposition. Nor are the GNSS satellites.)

In some examples, the purpose of the patrol mission is situation awareness. There is a desire to validate the “picture” of the situation in a particular portion of the sea/ocean, e.g. to identify problematic or unknown ships or other maritime traffic, and possibly to investigate them. The patrol mission aims to not rely only on the ship's/boat's asserted position, as broadcast on AIS and received, but wishes also to obtain a picture of the ship's actual position. The patrol validates the AIS position data against the actual measured position of the measured position. The aircraft matches absolute position based on AIS, to relative position of a ship from plane (e.g. range and direction) based on the RADAR blips. The mission module 348, in some examples, matches the RADAR data and the AIS data by superimposing the RADAR and AIS “pictures” (e.g. maps) of the situation.

Ships such 4 which do not broadcast their AIS ID and position are in some cases labelled as suspicious. So are ships such as 197 which broadcast a position that is geographically unreasonable (e.g. ship in Atlantic Ocean broadcasts that it is in the Pacific Ocean). So are ships which broadcast a ship ID which, per the internet feed, is in fact located far away. So are two ships which broadcast the same ID code via AIS, etc. Note that in other cases, the vessel that does not broadcast does not have a regulatory requirement to do so, or its AIS transponder is simply not functioning.

The mission module 348 also tracks the movement of some or all of the ships in the patrol region 410.

In some cases, the patrol aircraft attempts to get near the suspicious ship, to investigate it and possibly photograph it, in an attempt to identify it. In other cases, the patrol aircraft 105, or the external system 395, may instruct another vehicle, e.g. a police boat (not shown), to perform an investigation and approach the suspicious ship, e.g. the illegal fishing vessel.

Note that the success of the mission is based on the patrol aircraft's 105 own position being accurate. The mission module 348 knows the aircraft position Xv-abs, Yv-abs, and it knows the relative position XR11, YR11 of object 1. It thus knows the object's absolute position X-abs-11, Y-abs-11, and can match that to the absolute position X1, Y1 received in the AIS broadcast by Ship 1 191. Assuming that the RADAR and AIS positions are the same, or differ by less than a defined tolerance threshold, the two objects are assumed to be the same.

Some additional example advantages of the presently disclosed subject matter, for the patrol mission 400, are thus readily apparent. If the GNSS service via GNSS receiver 185 is disrupted or otherwise compromised, the position estimation will draft, and the aircraft 105 will eventually lose track of what its own position is. The aircraft will thus not be able to complete the patrol. In addition, the map it creates using RADAR and AIS data will be inaccurate, since its own reported position Xv-rep Yv-rep will be incorrect. The system in such a case assign absolute position to objects detected by the RADAR. For this reason as well, the mission will be a failure. For both of these reasons, the mission will be aborted, and not be accomplished, at least until the vehicle gets to location where it can recalculate its position (e.g. based on ground-based landmark). In some examples, this causes a waste of time and of the costs associated with the flight. In some cases, the mission is urgent, and its delay due to GNSS disruption is unacceptable.

In the case of the patrol mission, the solution of the presently disclosed subject matter can in some examples ensure that the mission is accomplished. In the example of the figure, the patrol aircraft has an AIS receiver and a RADAR, and mission-related software such as mission module 348. The presently disclosed method enables re-use of all of these systems/equipment/sensors/software. The addition of some software, to use the RADAR and AIS data (which is anyway captured) to determine Xv-abs, Yv-abs, will ensure that the patrol aircraft has a backup method of determining its own position, and need not rely entirely on the GNSS-based Xv-rep, Yv-rep. Once it can determine its own position, it can continue navigation, and it also can perform the mission calculations, even in the face of compromised GNSS. The mapping can be performed correctly, and the objects/ships, detected on maps 100 and 102, are correlated, thus e.g. enabling detection of suspicious objects/ships. In some examples this can be achieved at a relatively small additional cost.

Patrol missions are one non-limiting example of missions performed for the aircraft by e.g. mission module 348. Other non-limiting examples include Search and Rescue missions, performed e.g. by Search and Rescue Aircraft (SAR), navigation of offshore helicopter traffic, e.g. travelling to and from offshore drilling platforms, and for fleet tracking and management of e.g. helicopter fleets. See e.g. the web site http://avionetics.com/airborne_AIS.htm. In all of these mission applications, accurate position is required, even in cases of GNSS disruption, in order to enable navigation. In some cases, this is required to ensure safety, by preventing collisions between e.g. a helicopter and the drilling platform, and/or between two helicopters operating in the same area.

Attention is now drawn to FIG. 5, schematically illustrating an example generalized view of an object detection method 500, in accordance with some embodiments of the presently disclosed subject matter. The detection scenario 500 illustrates the use of one or more range finders 177, 385 and one or more cameras 177, 370, 375, 377, instead of the example use of a RADAR disclosed with reference to FIG. 2. Range finder(s) 385 measure the distances/ranges 121, 122, 123, 124 of the objects/ships 1, 2, 3, 4. Cameras 370, 375, 377 measure the angles A, B, C, D, e.g. angles relative to North. In the non-limiting example of the figure, a fixed camera 375 is mounted on the port side of vehicle 105, viewing one direction, and fixed camera 377 is mounted on the starboard side of the vehicle, viewing another direction. The use of two cameras is a non-limiting example. In another example, one or more cameras 370 mounted e.g. on a gimbal are utilized. The camera can take pictures while aimed at multiple viewing directions, rather than using multiple fixed cameras. In other examples, a combination of fixed and gimballed cameras is used.

Note also that in some cases, the solution of range finder plus camera(s) can position the aircraft 105 using only one ship/object 1, 191.

Note also that in some examples, range finder 385 has a comparatively short range, and thus the field of view 410 using such a solution is smaller than that using, for example, RADAR 389.

Note that in the figure, objects 5 and 6 are not shown.

Attention is now drawn to FIG. 6, schematically illustrating an example generalized view of an object detection method 600, in accordance with some embodiments of the presently disclosed subject matter. The detection scenario 600 illustrates the use of one or more cameras 177, 370, 375, 377, instead of the example use of a RADAR disclosed with reference to FIG. 2, or the solution of FIG. 5. Cameras 370, 375, 377 measure the angles A, B, C, e.g. angles relative to North. In the non-limiting example of the figure, a fixed camera 375 is mounted on the port side of vehicle 105, viewing one direction, and fixed camera 377 is mounted on the starboard side of the vehicle, viewing another direction. The use of two cameras is a non-limiting example. In another example, one or more cameras 370 mounted e.g. on a gimbal are utilized. In other examples, a combination of fixed and gimballed cameras is used. In the example of the figure, no range finder 385 is used.

The angles A, B, C describe lines in space 610, 620, 630. These lines intersect at a point 650. Point 650 is thus the relative position of vehicle 105, relative to objects 1, 2, 3. Using e.g. a map comparison as disclosed in FIG. 2, and the absolute positions of objects 191, 192, 193, these angles A, B, D can be used to find intersection point 650. Note that the camera-based solution of FIG. 6, in some examples, requires use of multiple objects 1, 2, 3 in order to position the aircraft 105.

The figure shows the non-limiting example of three intersecting lines. In some other examples, more or fewer objects (and thus angles A/lines 610) can be used. Note also that in the figure, objects 4, 5 and 6 are not shown.

Attention is now drawn to FIG. 7, schematically illustrating an example generalized view of an object detection method 700, in accordance with some embodiments of the presently disclosed subject matter. The detection scenario 700 illustrates the use of one or more range finders 177, 385, instead of the example use of a RADAR disclosed with reference to FIG. 2, or the example solution of FIG. 5 or 6. Range finder 385 measures the ranges/distances 121, 122, 123 (shown as broken lines) to vessels/objects 1, 2, 3. Conceptually, ranges 121, 122, 123 describe circles 710, 720, 730 (dashed-dotted lines), of radii 121, 122, 123. The circles are centered at objects 1, 2, 3. In such a case, the first matching (e.g. map overlay) of e.g. FIG. 2 looks for objects 191, 192, 193, around which virtual circles with radii of 121, 122, 123 meet. The meeting point 750 of these circles indicates the position of vehicle 105, and thus the absolute position Xv-abs, Yv-abs can be determined. In the example of the figure, no cameras 370, 375, 377 are used.

The figure shows the non-limiting example of three intersecting lines. In some other examples, more or fewer objects (and thus radii 121, 122) can be used. Note that if e.g. two objects 1, 2 are used, the circles intersect at two points. In some such cases, tracking of previous points/positions can be used to determine which intersection point represents the position of vehicle 105.

Note that the range-finder-based solution of FIG. 7, in some examples, requires use of multiple objects 1, 2, 3 in order to position the aircraft 105.

Note also that in some examples, range finder 385 has a comparatively short range, and thus the field of view 410 using such a solution is smaller than that using, for example, RADAR 389.

Note also that in the figure, objects 4, 5 and 6 are not shown.

Attention is now drawn to FIGS. 8A to 8D, illustrating one example generalized flow chart diagram, of a flow of a process or method 800, for positioning of a vehicle 105, in accordance with certain embodiments of the presently disclosed subject matter. This process is, in some examples, carried out by systems such as those disclosed with reference to FIG. 3.

The example flow starts at block 805 on FIG. 8A. According to some examples, a navigation problem is identified (block 805). In some examples, this block is performed by navigation system 360. In some examples, this identification comprised detection of disruption of the GNSS service.

Block 805 is relevant only in some implementations. In some other examples, the presently disclosed method is implemented on an ongoing basis, also at times when the GNSS is functioning well. In such a manner, the positions derived using the presently disclosed methods are already available, in a case that the GNSS can no longer be relied upon. In some examples, an ongoing comparison of the GNSS reported position, to that position derived using e.g. mapping of RADAR and AIS data, can be used to detect the GNSS disruption as it happens. If e.g. the deviation between the two positions is above a pre-defined threshold, this can be an indication of GNSS disruption. An alert can be sent of a suspected GNSS problem. In some such cases, from that point on only the presently disclosed method will be relied on for positioning, until such time as it is determined that GNSS function is back to normal (e.g. the deviation between the two positions is again below the defined threshold). See also, for example, blocks 865, 870 and 890 further herein.

According to some examples, a transmission, associated with one or more objects 191, 192 is received (block 810). In some examples, these objects are referred to herein as first objects. In some examples, this block is performed by receiver 178, e.g. an AIS receiver 178. In one example, the transmission is sent or broadcast by transmitters 179 or transponders 179, e.g. AIS transponders 179. In some examples, these transmissions comprise at least item(s) of object first position information associated with the first object(s), and/or item(s) of object identification information associated with the first object(s). In some examples, the object first position information is indicative of absolute position(s) of the first object(s).

According to some examples, an internet feed is received (block 812). In some examples, this is performed by internet interface 388. In some examples, the internet interface 388 receives from the internet 190, e.g. relayed via the satellite 198. However, the internet feed is in some cases delayed in time.

As disclosed above, in other examples only block 810 is performed, without block 812.

In still other examples, only block 812 is performed, without block 810. This latter implementation can work, for example, in cases where there are sufficient slow-moving vessels broadcasting AIS, to be able to perform the matching of geometric patterns of the position information received from the internet feed of AIS and from sensor/RADAR 177.

According to some examples, first information indicative of the transmission(s) is received (block 816). In some examples, this block is performed by transmission input module 324, operatively coupled to receiver 178 and/or to internet interface 388. In some examples the first information is indicative of an AIS transmission and/or of the internet feed update.

According to some examples, second position information of one or more object(s) 1, 2, 3 is received (block 820). In some examples, this block is performed by sensor input module 322, operatively coupled to sensor(s) 177 such as, for example, RADAR 389, range finder 385, and cameras 370, 375, 377. In some examples the second position information is indicative of a second relative position of the object(s), with respect to the vehicle 105.

According to some examples, a check is made, whether or not second information, and/or first information, has been received for sufficient number of objects (block 822). In some examples, this block is performed by sensor input module 322.

The definition of “sufficient/insufficient” is based e.g. on the navigation need, which in some cases is based in turn on the particular mission (patrol mission etc.). In one non-limiting illustrative example, the navigation need requires that AIS information be received by at least three ships with quality metrics of 9 or higher. In another non-limiting illustrative example, the need requires that the RADAR 389 detects at least five objects. According to some examples, in response to a determination at block 822 that “No”, second and/or first information has been received for only an insufficient number of objects, the process continues to block 824. According to some examples, an instruction and/or command is sent to the aircraft or other airborne vehicle 105, to increase its altitude (block 824). In some examples, this block is performed by sensor input module 322, communicating with e.g. navigation system 360 and/or operator user interface 392. In some other examples, it is performed by instructions/commands module 346. In some examples, the decision, to send the instruction and/or command, is made by Route Planning/Optimization Module 331. In the case of an instruction, an instruction can be sent to UI 392, alerting/indicating e.g. to the human pilot 391 that they should increase altitude. In the case of a command, a command can be sent to e.g. navigation system 360. In some examples, navigation system 360 autonomously moves aircraft 105.

According to some examples, an instruction and/or command is sent to the aircraft or other vehicle 105, to move to a geographical area comprising a larger number of objects (block 826). In some examples, this block is performed by sensor input module 322, communicating with e.g. navigation system 360 and/or operator user interface 392. In some other examples, it is performed by instructions/commands module 346. In some examples, the decision, to send the instruction and/or command, is made by Route Planning/Optimization Module 331.

In the case of an instruction, an instruction can be sent to UI 392, alerting/indicating e.g. to the human pilot 391 that they should move the vehicle. In the case of a command, a command can be sent to e.g. navigation system 360. In some examples, navigation system 360 autonomously moves vehicle 105.

In some examples, one of blocks 824 and 826, or both, are performed. In some examples, the aircraft 105 first increases altitude, in an attempt to detect a larger number of objects. If it still does not find a sufficient number, it then moves to another location, so as to be able to make a location fix.

In some examples, after performing blocks 824 and/or 826, the process reverts to block 810, to receive transmissions of first information and then continue in the process, or directly to block 820, to receive second position information.

According to some examples, in response to a determination at block 822 that “Yes”, that second and/or first information has been received for a sufficient number of objects, the process continues to block 830. According to some examples a quality metric, associated with a corresponding item of object identification information, is determined, for one or more of the first objects 191, 192 (block 830). In some examples, this is performed by objects prioritization and weighting module 326.

The process continues A to FIG. 8B.

According to some examples, one or more of the objects 191, 192 are selected, to be utilized in the determining of the derived position of vehicle 105, based on the quality metric of each object (block 832). In some examples, this is performed by objects prioritization and weighting module 326. For example, only ships with relatively high values of the quality metrics are selected, to be used for the position determination. More on this is disclosed further herein with reference to FIG. 2.

In one example, the flight plan of airplane 105 makes use of several trustworthy ships 191, 192, whose approximate positions are known e.g. via the internet feed 199B. These ships are at different locations within the sea/ocean, and they are chosen to serve as waypoints in the flight plan. As the plane will actually fly, it will look for the AIS broadcasts indicative of the ID information of these ships, so as to arrive at each waypoint in turn.

Several non-limiting example criteria for such selections are now disclosed, in addition to trustworthiness of the ship. The positioning system 310 in some cases will give preference to ships of a relatively low speed, the measured position of which will be more stable. For example, a slow oil tanker may be preferred over a speedboat, to server as a waypoint. Similarly, in some examples it is preferable to choose, for waypoints, ships that are in less densely populated regions of the sea, where the waypoint ship will stand out. This will reduce the probability of mistaking the trustworthy ship and a less trustworthy one, due to sensor 177 detecting two objects that are relatively close to each other.

Also, in some examples it is preferable to choose a ship which has a history of travelling the same route (e.g. an oil tanker), rather than a ship whose route can vary often. It is less likely that a fraudulent party will be able to disguise themselves as such a regular-route ship, in an AIS broadcast. The reason is that such broadcasts containing a first position that is far from the regular route will more likely be seen by the positioning system as indicative of a geographically unreasonable situation.

An additional example selection criterion is the usefulness of a particular ship during a comparatively large portion of the flight route. For example, Ship 1 191 is currently far from the aircraft 105, but it lies along the flight path. As the aircraft will approach Ship 1, later in the flight, it will be able to use it as an anchor point, and will be able to continue using Ship 1 as an anchor point also for some amount of time after passing the immediate vicinity of Ship 1.

One illustrative example of selecting waypoints is the following: the flight will be to 3 miles east of Ship 1 191, then will proceed to 2 miles southwest of Ship 5 195, and it will then proceed to 6 miles north of Ship 2 192. If during the flight there are GNSS problems, and the vehicle-deployed INS drifts, the vehicle 105 may use its self-positioning method disclosed herein, e.g. combined with dead reckoning, to get from waypoint to waypoint. Note that at least in some prior art implementations, such sea-based waypoints/anchor points/landmarks are not feasible.

In some examples, the logic/algorithm(s) used for ship selection will consider one or more of the following: aircraft 105 speed, aircraft 105 altitude (which affects how large an area the sensor 177 can see), direction of flight, the area(s) where the flight will occur, RADAR/sensor characteristics etc. It should be noted that an aircraft that can see a relatively large distance will have to handle data received from a comparatively larger number of objects/ships 191, 192.

According to some examples, object weights are assigned to one or more of the first objects 191, 192, based on the quality metric (block 834). In some examples, this is performed by objects prioritization and weighting module 326. More on this is disclosed further herein with reference to FIG. 2.

In some cases, more than one object has been selected to be utilized in the determining of the derived position of vehicle, at block 832. According to some examples, a plurality of unique sub-sets of objects of the plurality of objects are defined (block 837). In some examples, this is performed by objects prioritization and weighting module 326, or by map overlay module 330. As will be seen further herein, with reference to blocks 838, 849-852, in some examples the vehicle position will be derived/determined multiple times, where each derivation will utilize a different sub-set of the objects. In one illustrative example, a first interim value of the vehicle is calculated based on ships 191, 192, 193, a second interim value is calculated based on ships 191, 195, 196, and a third interim value is calculated based on ship 8, ship 9, ship 10 and ship 11. After the derivations of the multiple interim values, a final value will be determined.

Note that in some examples the defining of the plurality of unique sub-sets is based at least on the selecting of the objects to be utilized. That is, if in block 832 the object 191 is not selected for use, e.g. due to a low quality metric associated with low trustworthiness, that object 191 will not be assigned to any sub-set.

This implementation, using blocks 837, 838, 849-852 is an optional one. In other examples, the determination of vehicle 105 position is not performed for multiple sub-sets of the objects 192, 193, 195, 196. Note that if one object 1, 191 is selected for determination of vehicle 105 position, the blocks related to sub-sets will not used.

According to some examples, a sub-set of the unique sub-sets of objects is chosen for calculation purposed (block 838). The actions for position determination will be performed using this chosen sub-set. In some examples, this is performed by objects prioritization and weighting module 326, or by map overlay module 330. The next set of blocks 840-849 are performed with respect to this chosen sub-set.

According to some examples a first map 102, indicative of items of first position information, and a second map 100, indicative of second object relative position(s), are compared (block 840). In some examples, this is performed by position comparison module/map comparison module/map overlay module 330. In some examples, this comparison utilizes a map overlay 200, e.g. as disclosed further herein with reference to FIG. 2.

According to some examples, a first matching, of object second relative position XR11, YR11, XR12, YR12, of second object(s) 1, 2, with item(s) of object first position information associated with the first object(s) 191, 192, is performed (block 842). Recall that in some examples the item(s) of object first position information are indicative of the first object absolute positions X1, Y1, X2, Y2. In some examples, this is performed by position comparison module/map comparison module/map overlay module 330.

According to some examples, the absolute position information X1, Y1, X2, Y2 of the second object(s) 1, 2 is derived (block 842). In some examples, this is performed by position comparison module/map comparison module/map overlay module 330. In some examples, this derivation is based on the matching performed in block 842.

According to some examples, a second matching, of the first object(s) 191, 192 with the second object(s) 1, 2, is performed (block 846). In some examples, this is performed by position comparison module/map comparison module/map overlay module 330. In some examples, this second matching is based on the first matching. In some examples, each matched second object 1 is set to constitute a corresponding object 191 of the first objects 191, 192.

The process continues B to FIG. 8C.

According to some examples, an interim position determination is made for vehicle 105 (block 848). In some examples, this is performed by position comparison module/map comparison module/map overlay module 330. In some examples, the determination is based at least on the absolute position information of the corresponding object(s) 1, 191 and on the object second relative position(s), e.g. XR11, YR11.

In a case where the calculations are based on a sub-set 191, 192, 193 of the objects 191, 192, 193, 195, 196 (per e.g. block 838), the determination in block 848 is based on the sub-set.

An interim value of the derived vehicle 105 position is obtained. In some examples, this is indicative of an absolute position of the vehicle 105. Note that in a case where no sub-sets are used, this block makes a position determination that is not interim, and the derived position of the vehicle is not an interim value.

According to some examples, a position weight, associated with the interim value, is determined (block 849). In some examples, this is performed by objects prioritization and weighting module 326. In some examples, this position weight is determined, based on the object weights of the component objects of the particular sub-set. Thus, a sub-set whose component objects have higher quality metrics, and thus higher object weights, will yield higher position weights.

According to some examples, a check is made, whether or not all sub-sets of objects, defined in block 837, were processed, e.g. through some or all of blocks 838-849 (block 850). In some examples, this is performed by objects prioritization and weighting module 326, or by map overlay module 330.

According to some examples, in response to a determination at block 850 that “No”, not all defined sub-sets were processed, the flow reverts C to block 838 in FIG. 8B. In block 838, the next sub-set is chosen and is processed, to derive another weighted interim value of vehicle position.

According to some examples, in response to a determination at block 850 that “Yes”, all of the defined sub-sets were processed, the process continues to block 852. According to some examples, the repeated performance of the process of some or all of blocks 838-850 yields the derivation of a plurality of interim values of vehicle 105 position (block 852). In some examples, the plurality of interim values are associated with corresponding position weights. In some examples, this is performed by objects prioritization and weighting module 326, or by map overlay module 330.

According to some examples, certain interim value(s) are excluded from the determination process, under certain conditions (block 854). In some examples, this is performed by objects prioritization and weighting module 326, or by map overlay module 330.

An example condition for exclusions is that one or more interim values diverges significantly from one or more of the other interim values. Another example condition for exclusions is that one or more interim values diverges significantly from a prior derived position of the vehicle. The phrase “diverges significantly” refers e.g. to a case where a particular interim value of the plurality of interim values differs, above a defined threshold, from at least one of other interim values, and/or to a case where a particular interim value of the plurality of interim values differs, above a defined threshold, from a prior derived position of the vehicle. Cross-checks of the various interim values are performed. As one example of this, if most of the interim position values are within a few meters or tens of meters of each other, and one other interim value is a position a few km away from the others, this value is anomalous, and the divergent value is excluded. Similarly, if a derived interim value is many km away from the previously determined position of vehicle 105, this value is anomalous, and the divergent value is excluded. In these cases, the excluded values are “outliers”.

According to some examples, the plurality of interim values are weighted (block 856). In some examples the weighting is performed based at least on the corresponding position weights, derived in block 849. In some examples, this is performed by objects prioritization and weighting module 326, or by map overlay module 330. In some other examples, the weighting in block 856 is based directly on the object weight of each object (assigned in block 834.)

Note also, that in some examples, of cases in which sub-sets of objects are not used, and in which the positioning is based on multiple ships/objects, the absolute vehicle 105 positions Xv-abs-3, Yv-abs-3, Xv-abs-5, Yv-abs-5 (which are each derived using a different object 3, 193, 5, 195) are weighted, e.g. based on the object weight of the relevant objects 193, 195.

The process continues C to FIG. 8D.

According to some examples, a final value, of the derived position of the vehicle, is derived (block 860). In some examples, this is performed by aggregation/final determination module 335, or by map overlap module 330. In some examples, this final value is a derived absolute position Xv-abs, Yv-abs of vehicle 105. In some examples, this final value is set to constitute the derived position of the vehicle.

Note that in cases where sub-sets of objects are not used, block 860 is in some examples identical to block 848.

According to some examples, a deviation between the derived position and the reported position of the vehicle is determined (block 865). In some examples, this is performed by deviation calculation module 340. As disclosed above, the reported position Xv-rep, Yv-rep refers to that obtained utilizing the GNSS receivers 185, while the derived position is that derived, for example, in blocks 848 or 860.

According to some examples, one or more alerts, indicative of the determined deviation, are sent (block 870). In some examples, this is performed by alert module 344. In some examples, the alert(s) is sent to a user interface 391 associated with a human operator 391, navigation system 360 (which in some examples is an autonomous navigation system), and/or to an external system 395.

In one example, the alert tells human operator 391, and/or a human operator in external system 395, that the deviation between the two positions is above threshold, and that the GNSS service may be disrupted. This can enable the operator to, for example, manually switch the navigation system 360 to begin using the derived position instead of the GNSS-reported position.

In another example, the alert indicates to autonomous navigation system 360 to begin using the derived position instead of the GNSS-reported position. In still another example, the alert indicates to external system 395, that it should send a command e.g. automatically, to navigation system 360 to begin using the derived position instead of the GNSS-reported position.

According to some examples, one or more correction instructions, and/or commands, are sent (block 875). The instructions/commands are to correct the reported position Xv-rep, Yv-rep of the vehicle. In some examples, this is performed by instructions/commands module 346.

In some examples, the instruction is sent to at least to a user interface 391 associated with a human operator 391, to navigation system 360, and/or to an external system 395. In one example, the instruction advises human operator 391, and/or a human operator in external system 395, that the position of the vehicle should be corrected, based on the derived position, of e.g. block 860. This advisory information can facilitate the operator to, for example, performing the correction on the appropriate system.

In some examples, the command is sent to navigation system 360, which in some examples is an autonomous navigation system, and/or to an external system 395. In one example, the command indicates to autonomous navigation system 360 that it should correct the GNSS-reported position Xv-rep, Yv-rep of the vehicle, based on to begin using the derived position, e.g. to use the derived position Xv-abs, Yv-abs of the vehicle, of e.g. block 860. In still another example, the command indicates to external system 395, that it should send a command, e.g. automatically, to navigation system 360 to correct the GNSS-reported position.

In some examples, the result of this block is to derive a corrected reported position of the vehicle.

Note that blocks 865-875, of deviation calculation, alert, and instructions/commands for position correction, can all be considered outputs of the process for determining the position Xv-abs, Yv-abs of vehicle/aircraft 105.

According to some examples, the vehicle 105 is navigated, based on the corrected reported position of the vehicle which was derived in block 875 (block 880). In some examples, this is performed by navigation/guidance system 360. In some examples, the navigation is to the next waypoint(s). Note that some examples, also the vehicle's heading/bearing, speed etc. can be determined, e.g. by determining multiple positions which are based on data that was captured at different points in time during the vehicle movement.

According to some examples, the mission task is performed (block 885). In some examples, this is performed by mission module 348. FIG. 4 discloses the non-limiting example of a patrol mission. In such a mission, the task performed in block 885 is, for example, identifying suspicious boats/ships 4, 197 which may require further investigation. Note that block 885 is shown here for ease of exposition only. In some examples, the mission task is being performed 885 in parallel with the aircraft's 105 self-positioning process, that is in parallel with all or part of flow chart 8A-8D.

According to some examples, the vehicle position history is tracked (block 890). The process, of some or all of e.g. blocks 810-885, is performed for a next point in time.

In some examples, the flow loops back to block 810. This is in some examples performed repeatedly. The positioning system thus continually obtains corrected positions of vehicle 105, and these positions are tracked. In some examples, this block is performed by position history module 333.

Recall that such tracking of the position history can in some cases be used to identify GNSS disruptions. If the GNSS reported position, and the derived position, are similar over time, and suddenly at time Ti the GNSS-based position is very different from the earlier position values, this can be an indication that the GNSS service has in some way been compromised.

In some other examples, portions of the flow are performed by systems other than positioning system 310. For example, a patrol mission system can provide some or all of the AIS transmission data and RADAR data, and possible one or both of maps 100 and 102. This can serve as an input to positioning system 310, which uses these inputs to calculate the vehicle 105 position and to navigate.

Note that the above description of process flow 800 is a non-limiting example only.

In some embodiments, one or more steps of the flowchart exemplified herein may be performed automatically. The flow and functions illustrated in the flowchart figures may for example be implemented in system 310 and in processing circuitry 312, and they may make use of components described with regard to FIG. 3. It is also noted that whilst the flowchart is described with reference to system elements that realize steps, such as for example systems 310, and processing circuitry 312, this is by no means binding, and the operations can be carried out by elements other than those described herein.

It is noted that the teachings of the presently disclosed subject matter are not bound by the flowcharts illustrated in the various figures. The operations can occur out of the illustrated order. One or more stages illustrated in the figures can be executed in a different order and/or one or more groups of stages may be executed simultaneously. As one non-limiting example, blocks 810 and 812, shown in succession, can be executed substantially concurrently, or in a different order. The same applies to e.g. blocks 820 and 816, and to blocks 865 and 870.

Similarly, some of the operations or steps can be integrated into a consolidated operation, or can be broken down into several operations, and/or other operations may be added. As a non-limiting example, in some cases blocks 832 and 834 can be combined. The same applies to e.g. blocks 842 and 844, and to 822, 824 and 826.

In embodiments of the presently disclosed subject matter, fewer, more and/or different stages than those shown in the figures can be executed. As one non-limiting example, certain implementations may not include the blocks 824 and/or 826. The same applies to e.g. blocks 837-838 and 849-856, associated with sub-sets of objects.

In the claims that follow, alphanumeric characters and Roman numerals, used to designate claim elements such as components and steps, are provided for convenience only, and do not imply any particular order of performing the steps.

It should be noted that the word “comprising” as used throughout the appended claims, is to be interpreted to mean “including but not limited to”.

While there has been shown and disclosed examples in accordance with the presently disclosed subject matter, it will be appreciated that many changes may be made therein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be, at least partly, a suitably programmed computer. Likewise, the presently disclosed subject matter contemplates a computer program product being readable by a machine or computer, for executing the method of the presently disclosed subject matter, or any part thereof. The presently disclosed subject matter further contemplates a non-transitory machine-readable or computer-readable memory tangibly embodying a program of instructions executable by the machine or computer for executing the method of the presently disclosed subject matter or any part thereof. The presently disclosed subject matter further contemplates a non-transitory computer readable storage medium having a computer readable program code embodied therein, configured to be executed so as to perform the method of the presently disclosed subject matter.

Those skilled in the art will readily appreciate that various modifications and changes can be applied to the embodiments of the invention as hereinbefore described without departing from its scope, defined in and by the appended claims.

1-50. (canceled)

51. A computerized positioning system associated with a vehicle, the computerized positioning system comprising:
a processing circuitry configured to perform the following method:
a. receive first information indicative of at least one transmission,
wherein the transmission is associated with at least one object,
wherein the first information comprises at least one item of object first position information associated with the at least one object,
wherein the at least one item of object first position information is indicative of an absolute position of the at least one object;
b. receive second position information of the at least one object, the second position information being indicative of a second relative position of the at least one object with respect to the vehicle; and
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.

52. The computerized positioning system of claim 51, wherein the method further comprising:
d. determining a deviation between the derived position and the reported position of the vehicle.

53. The computerized positioning system of claim 52, wherein the method further comprising at least one of the following:
e. sending an alert indicative of the determined deviation; or
f. sending a correction instruction to correct the reported position of the vehicle, thereby deriving a corrected reported position of the vehicle.

54. The computerized positioning system of claim 53,
wherein the alert is sent to at least one of: a user interface associated with a human operator; an autonomous navigation system; or an external system,
wherein the instruction is sent to at least one of: a user interface associated with a human operator; an autonomous navigation system; or an external system.

55. The computerized positioning system of claim 53, wherein the method further comprising at least one of the following:
g. navigating the vehicle based on the corrected reported position of the vehicle; or
h. performing at least one repetition of the method, the repetition thereby enabling a tracking of the corrected reported position.

56. The computerized positioning system of claim 51, wherein at least one of the following is true:
(A) the first information comprises at least one item of object identification information of the at least one object;
(B) the derived position is capable of being utilized in a case of a disruption associated with the at least one GNSS signal;
(C) the at least one received GNSS signal and the at least one GNSS receiver are associated with at least one of the following technologies: Global Positioning System (GPS), Global Navigation Satellite System (GLONASS) and Galileo;
(D) the transmission is received from at least one of a transmitter and a transponder that are associated with the at least one object;
(E) the vehicle is associated with a receiver configured for receiving the transmission;
(F) the object first position information associated with the at least one object comprises GNSS position information of the at least one object;
(G) the object first position information associated with the at least one object;
the determining of the derived position of the vehicle in said step (c), based at least on the first information and on the second position information, comprises determining a derived absolute position of the vehicle;
(H) the receiving of the first information comprises receiving an internet feed indicative of the first information,
wherein the determining of the derived position of the vehicle is based at least on the internet feed; or
(I) the vehicle is associated with at least one sensor,
wherein the second position information being based on sensor data obtained from the at least one sensor,
wherein the second relative position comprising a range of the at least one object and at least one relative angle of the at least one object.

57. The computerized positioning system of claim 56, wherein at least one of the following is true:
(i) the disruption comprises least one: of jamming, interference or spoofing of the at least one GNSS signal, GNSS receiver failure, GNSS antenna failure;
(ii) the transponder is an Automatic Identification system (AIS) transponder;
(iii) the object identification information of the at least one object comprises at least one of: a MMSI (Maritime Mobile Service Identity); a name of the at least one object, a call sign of the at least one object;
(iv) the internet feed comprises an internet update of AIS information;
(v) the internet feed is received from at least one satellite;
(vi) the at least one sensor comprises at least one of: a Radio Detection and Ranging (RADAR) system; an Identification Friend or Foe (IFF) system; and Automatic Dependent Surveillance-Broadcast (ADS-B) system; or
(vii) the at least one sensor comprising a range finder and at least one imaging sensor.

58. The computerized positioning system of the claim 56,
wherein the receiving of the second position information comprises receiving second position information indicative of an object second relative position of at least one second object with respect to the vehicle,
wherein the determining of the derived absolute position of the vehicle in said step (c) comprises:
i. perform a first matching of the object second relative position, of the at least one second object, with the at least one item of object first position information, comprised in the first information, associated with the at least one first object,
thereby deriving absolute position information of the at least one second object;
ii. setting each matched second object of the at least one second object to constitute a corresponding object of the at least one object; and
iii. determine the derived absolute position of the vehicle based at least on absolute position information of the corresponding object and on the at least one object second relative position.

59. The computerized positioning system of claim 58, wherein at least one of the following is true:
(I) the first matching is based on the at least one item of object first position information, and the object relative second position, being indicative of a same position, within a defined tolerance;
(II) the at least one object comprises a plurality of objects,
wherein said step (c) (iii) comprises determining the derived absolute position of the vehicle based at least on absolute position information of a plurality of corresponding objects and on object second relative positions of the plurality of corresponding objects;
(III) the first matching comprises comparing a first map and a second map, the first map being indicative of the at least one item of object first position information, the second map being indicative of the at least one object second relative position; or
(IV) the setting each matched second object comprises: performing a second matching of the at least one object, with the at least one second object, based on the first matching.

60. The computerized positioning system of claim 59, wherein the setting each matched second object further comprising:
associating the object identification information of the each matched second object with the corresponding object of the at least one object.

61. The computerized positioning system of claim 57, wherein the at least imaging sensor comprising at least one camera.

62. The computerized positioning system of claim 51,
wherein the at least one object comprises a plurality of objects,
wherein the determining of the derived position of the vehicle is based on an intersection of second relative positions of objects of the plurality of objects.

63. The computerized positioning system of claim 56,
wherein the at least one object comprises a plurality of objects,
wherein the determining of the derived position of the vehicle in said step (c) further comprises:
iv. for each object of the plurality of objects, determining a quality metric associated with a corresponding item of object identification information; and
V. performing at least one of the following:
(1) select objects of the plurality of objects, to be utilized in the determining of the derived position, based on the quality metric of the each object; and
(2) assigning an object weight of the each object, based on the quality metric, and determining the derived position at least based on the object weight.

64. The computerized positioning system of claim 63, wherein the quality metric of the each object is based at least on a level of geographic reasonableness associated with a corresponding item of object first position information of the each object.

65. The computerized positioning system of claim 63,
wherein the determining of the derived position in said step (c) further comprises the following:
vi. defining a plurality of unique sub-sets of objects of the plurality of objects;
vii. performing an interim position determination, based on a sub-set of the plurality of unique sub-sets,
viii. thereby obtaining an interim value of the derived position of the vehicle;
ix. determining a position weight associated with the interim value;
x. repeating said steps vi to viii for each sub-set of the plurality of unique sub-sets,
thereby deriving a plurality of interim values associated with corresponding position weights; and
xi. weight the plurality of interim values, based at least on the corresponding position weights,
thereby deriving a final value of the derived position of the vehicle, the final value constituting the derived position of the vehicle.

66. The computerized positioning system of claim 60, wherein at least one of the following is true:
(a) the defining of the plurality of unique sub-sets is based at least on the selecting of the objects to be utilized; or
(b) the determining of the position weight is based at least on a corresponding object weight of each object in the sub-set.

67. The computerized positioning system of claim 51, wherein at least one of the following is true:
(i) the determining of the derived position of the vehicle utilizes a geo-registration process;
(ii) the method further comprising, in a case where the second position information is indicative of an insufficient number of the at least one object, sending an instruction to the vehicle to increase the altitude; or
(iii) the method further comprising, in a case where the second position information is indicative of an insufficient number of the at least one object, sending an instruction to the vehicle to move to a geographical area comprising a larger number of objects.

68. The computerized positioning system of claim 51, wherein at least one of the following is true:
[1] the at least one object is one object;
[2] the vehicle is an airborne vehicle;
[3] the airborne vehicle is a patrol aircraft
[4] the airborne vehicle is an Unmanned Aerial Vehicle (UAV);
[5] the at least one object comprises at least one water-borne vehicle;
[6] the at least one water-borne vehicle comprises at least one ship; or
[7] the at least one object comprises at least one fixed-position object.

69. A computerized method of positioning a vehicle, the computerized method configured to be performed by a computerized positioning system comprising a processing circuitry, the method comprising, performing the following by the processing circuitry:
a. receive first information indicative of at least one transmission,
wherein the transmission is associated with at least one object,
wherein the first information comprises at least one item of object first position information associated with the at least one object,
wherein the at least one item of object first position information is indicative of an absolute position of the at least one object;
b. receive second position information of the at least one object, the second position information being indicative of a second relative position of the at least one object with respect to the vehicle; and
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.

70. A non-transitory computer readable storage medium tangibly embodying a program of instructions that, when executed by a computerized positioning system, cause the computer to perform a computerized method of positioning a vehicle, the computerized method being performed by a processing circuitry of the computerized positioning system and comprising performing the following actions:
a. receive first information indicative of at least one transmission,
wherein the transmission is associated with at least one object,
wherein the first information comprises at least one item of object first position information associated with the at least one object,
wherein the at least one item of object first position information is indicative of an absolute position of the at least one object;
b. receive second position information of the at least one object, the second position information being indicative of a second relative position of the at least one object with respect to the vehicle; and
c. determine a derived position of the vehicle, based at least on the first information and on the second position information;
wherein the derived position of the vehicle is capable of being utilized to facilitate a correction in a reported position of the vehicle,
wherein the reported position of the vehicle is based on at least one Global Navigation Satellite Systems (GNSS) signal received by at least one GNSS receiver associated with the vehicle.
